(19) United States
(12) Patent Application Publication
(10) Pub. No.: US 2023/0192206 A1
(43) Pub. Date: Jun. 22, 2023

(54) PAYLOAD SYSTEM FOR A BICYCLE AND OTHER OBJECTS

(71) Applicant: JONAH DAVID ELGART, Somerville, MA (US)

(72) Inventor: JONAH DAVID ELGART, Somerville, MA (US)

(21) Appl. No.: 18/082,920

(22) Filed: Dec. 16, 2022

Related U.S. Application Data
(60) Provisional application No. 63/265,908, filed on Dec. 22, 2021.
(60) Provisional application No. 63/362,748, filed on Apr. 10, 2022.
(60) Provisional application No. 63/377,036, filed on Sep. 25, 2022.

(51) Int. Cl. B62H 3/10; B62J 7/04

(52) U.S. Cl. CPC B62H 3/10; B62J 7/04

(57) ABSTRACT

A payload device capable of attaching to a host-bicycle and carrying a payload-bicycle or other cargo objects includes a back-section, a base, payload-securing components, and mounting-components. The back-section includes a vertically extending structure and the base includes a horizontally extending structure, and a bottom edge of the back-section is adjacent to a back edge of the base. The base has an elongated opening shaped and dimensioned to accommodate a wheel of the payload bicycle. The payload-securing components are capable of removably attaching the wheel of the payload bicycle or other cargo objects to the back-section. The mounting components are capable of removably attaching the payload device to the host bicycle.

### CROSS REFERENCE TO RELATED CO-PENDING APPLICATIONS

This application claims the benefit of U.S. provisional application Ser. No. 63/265,908 filed on Dec. 22, 2021 and entitled PAYLOAD SYSTEM FOR BICYCLE AND OTHER OBJECTS, which is commonly assigned and the contents of which are expressly incorporated herein by reference.

This application claims the benefit of U.S. provisional application Ser. No. 63/362,748 filed on Apr. 10, 2022 and entitled PAYLOAD SYSTEM FOR BICYCLE AND OTHER OBJECTS, which is commonly assigned and the contents of which are expressly incorporated herein by reference.

This application claims the benefit of U.S. provisional application Ser. No. 63/377,036 filed on Sep. 25, 2022 and entitled PAYLOAD SYSTEM FOR BICYCLE AND OTHER OBJECTS, which is commonly assigned and the contents of which are expressly incorporated herein by reference.

### FIELD OF THE INVENTION

The present invention relates to a payload system for a bicycle and other objects, and more particularly, to a payload system that is configured to attach to a host-bicycle and to carry another bicycle and/or other cargo objects.

### BACKGROUND OF THE INVENTION

There are several bicycle towing devices in the market. There are also several bicycle racks used primarily to carry cargo objects. However, most current bicycle towing devices interfere with the riding ability of the host-bicycle (towing bicycle), and are difficult to use. In some cases the stability of the payload-bicycle (bicycle being towed) is compromised during transport and could become dangerous for the rider of the host-bicycle. There are also currently no other devices that are easy to use and can be used both for towing another bicycle and for carrying cargo objects with a conventionally sized bicycle rack.

Accordingly, there is a need for payload systems that can easily attach to a host-bicycle and carry another bicycle and/or other cargo objects without interfering with the riding ability of the host-bicycle and the stability of the towed bicycle.

### SUMMARY OF THE INVENTION

The invention provides a payload system that is configured to attach to a host bicycle and to carry another bicycle and/or other cargo objects.

In general, in one aspect the invention provides a payload device capable of attaching to a host-bicycle and carrying a payload-bicycle and/or other cargo objects. The payload device includes a back-section, a base, and payload-securing components. The back-section includes a vertically extending structure and the base includes a horizontally extending structure, and a bottom edge of the back-section is adjacent to a back edge of the base. The base has an elongated opening shaped and dimensioned to accommodate a wheel of the payload bicycle. The payload-securing components are capable of removably attaching the wheel of the payload bicycle or other cargo objects to the back-section.

Implementations of this aspect of the invention include the following. The back-section includes a vertically-extending flat board and the base comprises a horizontally-extending flat board. The back-section includes a vertically-extending tubular frame and the base comprises a horizontally-extending tubular frame. The back-section further comprises a sheet connected to the tubular frame. The base comprises angled support brackets or U-shaped support brackets. The elongated opening of the base extends diagonally at an angle relative to the back edge of the base. The base is hingeably connected to the back-section and foldable toward the back-section. The base further includes an integrated stabilizer support. The back-section is foldable along one or more locations. A leading edge of the base is set back relative to the host-bicycle's rear wheel axle. The payload-securing components include one or more straps and one or more strap anchors. The payload-securing components include a fork catcher, or a trip-prevention nub. The device further includes mounting components capable of removably attaching the payload device to the host bicycle. The mounting components include a mounting bar and the mounting bar is capable of attaching to a location of the host-bicycle and the location may be one of a seat post, seat tube, seat stay, chainstay, seat stay eyelets, or bicycle rack. The mounting components are capable of attaching the back-section to a location of the host-bicycle and the location may be one of a seat post, seat tube, seat stay, chainstay, seat stay eyelets, dropout eyelets, wheel axle, or bicycle rack. The mounting components include a mounting U-bar and the mounting U-bar is capable of attaching to a location of the host-bicycle and the location may be one of a rear dropout eyelets, seat stay, chainstay, or wheel axle. The mounting components include one or more latches, a catch, a latch-rail and a catch-rail and the latch-rail and catch-rail are mounted on a back surface of the back-section and the one or more latches and the catch are slidably mounted to the latch-rail and catch-rail, respectively. The mounting components include one or more of J-hooks, a handle, a tension hook, a tension hook guide, or a bungee cord. The back-section includes components integrated on a back-section surface and the integrated components include at least one of tracks, and slots. The tracks extend horizontally, vertically, or arcwise and the slots may have one of linear shapes, arc shapes, U-shapes, circular shapes, oval shapes, cross-shapes, or H-shapes. The device further includes a bicycle rack mountable over a wheel of the host-bicycle and the back-section is mounted to the bicycle rack. The device further includes a trip-prevention strap having a first end connectable to the payload-bicycle and a second end connectable to the host-bicycle.

In general, in another aspect the invention provides a payload device capable of attaching to a host-bicycle and carrying a payload-bicycle or other cargo objects including a back-section, a base, payload-securing components, and mounting-components. The back-section and base comprise a continuous flexible sheet that is foldable and capable of forming a sling. The base has an elongated opening shaped and dimensioned to accommodate a wheel of the payload bicycle. The payload-securing components are capable of removably attaching the wheel of the payload bicycle or other cargo objects to the back-section, and the mounting components are capable of removably attaching the payload device to the host bicycle. The flexible sheet comprises reinforced ribs that are rigid in one direction and flexible in another direction.

In general, in another aspect the invention provides a payload device capable of attaching to a host-bicycle and carrying a payload-bicycle or other cargo objects including a horizontally extending tubular component, a vertically extending tubular component having a first end connected to the horizontally extending tubular component and a hook-shaped second end. The hook-shaped end is capable of engaging an axle of the payload-bicycle or other cargo objects. The vertically extending tubular component is foldable toward the horizontally extending component. The vertically extending component is slidably connected to the horizontally extending tubular component and is capable of sliding vertically up and down. The vertically extending tubular component further includes one or more additional hooks capable of engaging an axle of the payload-bicycle and a hanging length of the one or more hooks is adjusted by sliding the vertically extending tubular component up and down.

The details of one or more embodiments of the invention are set forth in the accompanying drawings and description below. Other features, objects, and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 depicts a payload system mounted on a host-bicycle with a payload-bicycle in tow according to this invention;

FIG. 2 is a front perspective view of a payload device, according to this invention;

FIG. 3 is a back perspective view of the payload device of FIG. 2;

FIG. 4A is a front perspective view of another embodiment of a payload device according to this invention;

FIG. 4B is an exploded view of a front area of the base of the payload device of FIG. 4A;

FIG. 5A is a back perspective view of the payload device of FIG. 2 mounted on a bicycle rack that is attached to the back wheel of the host-bicycle;

FIG. 5B is a back perspective view of the payload device of FIG. 2 mounted on a bicycle rack with the host-bicycle and a section of the bicycle rack being cut away;

FIG. 6 is a back perspective view of another embodiment of a payload device according to this invention, with a portion of the device and the bicycle rack being cut away;

FIG. 7 is a back perspective view of yet another embodiment of a payload device according to this invention, with a portion of the device and the bicycle rack being cut away;

FIG. 8 is a back perspective view of yet another embodiment of a payload device according to this invention, with a portion of the device and the bicycle rack being cut away;

FIG. 9 is a backside perspective view of yet another embodiment of a payload device according to this invention, with a portion of the bicycle being cut away;

FIG. 10 is a backside perspective view of yet another embodiment of a payload device according to this invention, with a portion of the bicycle being cut away;

FIG. 11 is a back perspective view of yet another embodiment of a payload device according to this invention, with a portion of the bicycle being cut away;

FIG. 12 is a back perspective view of yet another embodiment of a payload device according to this invention, with a portion of the bicycle being cut away;

FIG. 13 is a front perspective view of yet another embodiment of a payload device according to this invention, mounted on a host-bicycle with a child's sized (16″ diameter wheels) payload-bicycle in tow;

FIG. 14 is a front perspective view of the payload device of FIG. 13, mounted on a host-bicycle with an adult's sized (700c diameter wheels) payload-bicycle in tow;

FIG. 15 is a front perspective view of the payload device of FIG. 13, mounted on a host-bicycle with a large box as a payload in tow;

FIG. 16A is a front perspective view of yet another embodiment of a payload device according to this invention;

FIG. 16B is a front perspective view of the payload device of FIG. 16A with the base folded;

FIG. 16C is a front perspective view of the payload device of FIG. 16A with the base and a portion of the backside folded;

FIG. 17 is a front perspective view of yet another embodiment of a payload device according to this invention;

FIG. 18 is a front perspective view of yet another embodiment of a payload device according to this invention;

FIG. 19 is a front perspective view of yet another embodiment of a payload device according to this invention;

FIG. 20 is a front perspective view of yet another embodiment of a payload device according to this invention;

FIG. 21A is a front perspective view of yet another embodiment of a payload device according to this invention;

FIG. 21B is a front perspective view of the payload device of FIG. 21A in a folded state;

FIG. 22 is a front perspective view of yet another embodiment of a payload device according to this invention;

FIG. 23 is a front perspective view of yet another embodiment of a payload device according to this invention;

FIG. 24 is a front perspective view of yet another embodiment of a payload device according to this invention;

FIG. 25 is a front perspective view of yet another embodiment of a payload device according to this invention;

FIG. 26 is a front perspective view of yet another embodiment of a payload device according to this invention;

FIG. 27 is a front perspective view of yet another embodiment of a payload device according to this invention;

FIG. 28 is a front perspective view of yet another embodiment of a payload device according to this invention;

FIG. 29 is a front perspective view of yet another embodiment of a payload device according to this invention;

FIG. 30 is a front perspective view of yet another embodiment of a payload device according to this invention;

FIG. 31 is a front perspective view of yet another embodiment of a payload device according to this invention;

FIG. 32 is a front perspective view of yet another embodiment of a payload device according to this invention;

FIG. 33 is a front perspective view of yet another embodiment of a payload device according to this invention, depicting the payload device mounted on a host-bicycle and towing a child's size payload-bicycle;

FIG. 34 is a front perspective view of yet another embodiment of a payload device according to this invention;

FIG. 35 is a front perspective view of yet another embodiment of a payload device according to this invention, mounted on a host-bicycle;

FIG. 36 is a front perspective view of yet another embodiment of a payload device according to this invention, mounted on a host-bicycle;

FIG. 37 is a front perspective view of yet another embodiment of a payload device according to this invention, mounted on a host-bicycle;

FIG. 38 is a front perspective view of the payload device of FIG. 13 mounted on a front rack of the host-bicycle;

FIG. 39 is a front perspective view of the payload device of FIG. 13 mounted on a front rack of the host-bicycle pointing in an opposite direction relative to FIG. 38;

FIG. 40 is a front perspective view of yet another embodiment of a payload device according to this invention, mounted on a host-bicycle;

FIG. 41 is a front perspective view of yet another embodiment of a payload device according to this invention;

FIG. 42 is a front perspective view of yet another embodiment of a payload device according to this invention;

FIG. 43 is a front perspective view of yet another embodiment of a payload device according to this invention, mounted on a rear rack of the host-bicycle and towing a child's size bicycle;

FIG. 44A is a front perspective view of yet another embodiment of a payload device according to this invention;

FIG. 44B is a back perspective view of the payload device of FIG. 44A;

FIG. 45 is a perspective view of a fork-catch component used in connection with the payload device of FIG. 44A;

FIG. 46 is a front perspective view of yet another embodiment of a payload device according to this invention;

FIG. 47 depict various anchor slot patterns used in connection with the payload device of FIG. 44A;

FIG. 48 is a front perspective view of yet another embodiment of a payload device according to this invention;

FIG. 49A-FIG. 49E depict various configurations of the slotted opening 4416 of the embodiment of FIG. 44A;

FIG. 50 is a front view of yet another embodiment of a payload device according to this invention;

FIG. 51 is a back view of the payload device of FIG. 50;

FIG. 52 depicts the payload device of FIG. 50 mounted on the rear rack of the host-bicycle;

FIG. 53 depicts the payload device of FIG. 50 mounted on the rear rack of the host-bicycle with a child's size bicycle in tow;

FIG. 54 depicts the payload device of FIG. 50 mounted on the rear rack of the host-bicycle with an adult's size bicycle in tow;

FIG. 55 depicts the payload device of FIG. 50 mounted on the rear rack of the host-bicycle with a box as a payload;

FIG. 56 depicts the payload device of FIG. 50 mounted on the rear rack of the host-bicycle with a rolled rug as a payload;

FIG. 57 depicts the payload device of FIG. 50 mounted on the rear rack of the host-bicycle with a suitcase as a payload;

FIG. 58 depicts the payload device of FIG. 50 mounted on the rear rack of the host-bicycle with an infant's jumper toy as a payload;

FIG. 59 is a front perspective view of yet another embodiment of a payload device according to this invention;

FIG. 60A depicts yet another embodiment of a payload device according to this invention;

FIG. 60B depicts the embodiment of the payload device of FIG. 60A including back-sections; and

FIG. 60C depicts the embodiment of the payload device of FIG. 60A mounted on the host-bicycle.

### DETAILED DESCRIPTION OF THE INVENTION

The invention provides payload devices that are configured to attach to a host bicycle and to tow and/or carry another bicycle and/or other cargo objects.

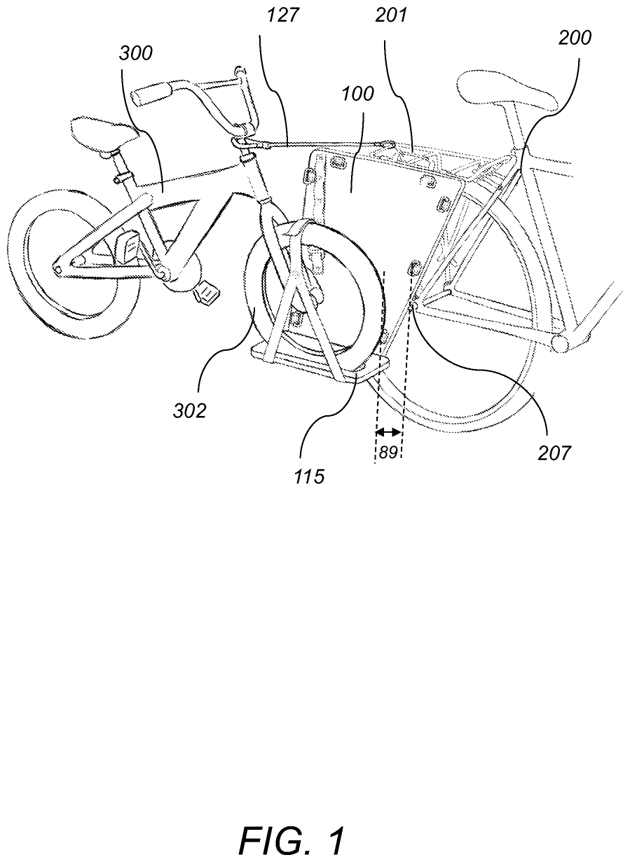

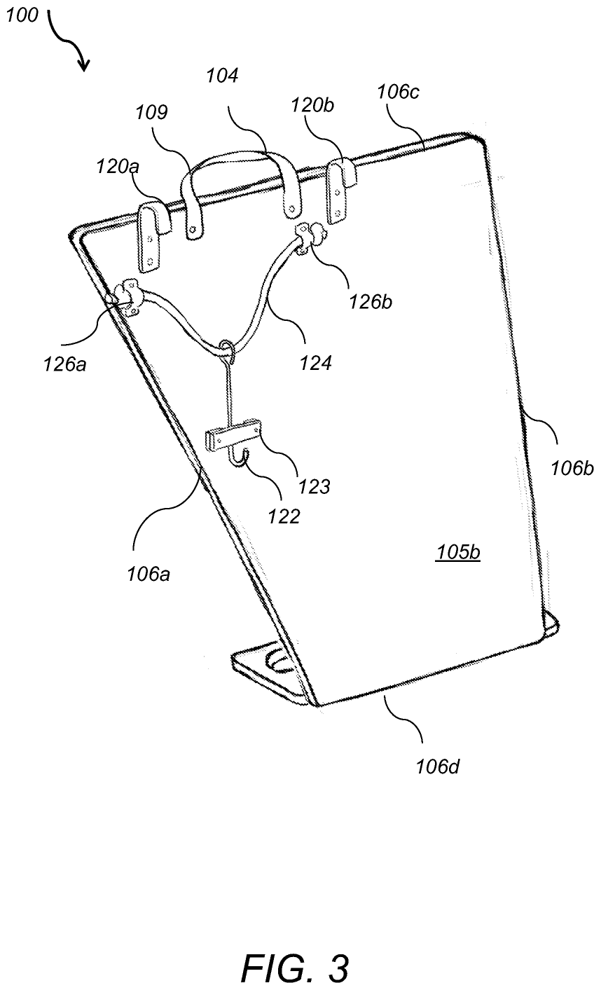

Referring to FIG. 1, a payload device 100 is attached to a host-bicycle 200 and is configured to support and carry a payload-bicycle 300. In this embodiment, the payload device 100 hangs from a rail of a bicycle rack 201 that is mounted on the rear of the host-bicycle 200 via J-hooks 120a and 120b, shown in FIG. 3.

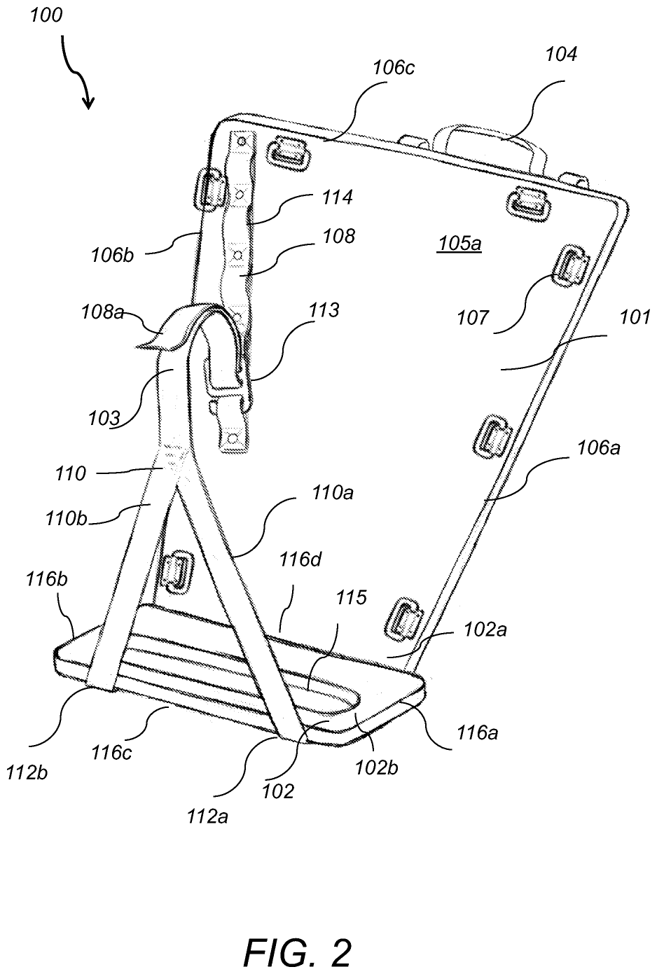

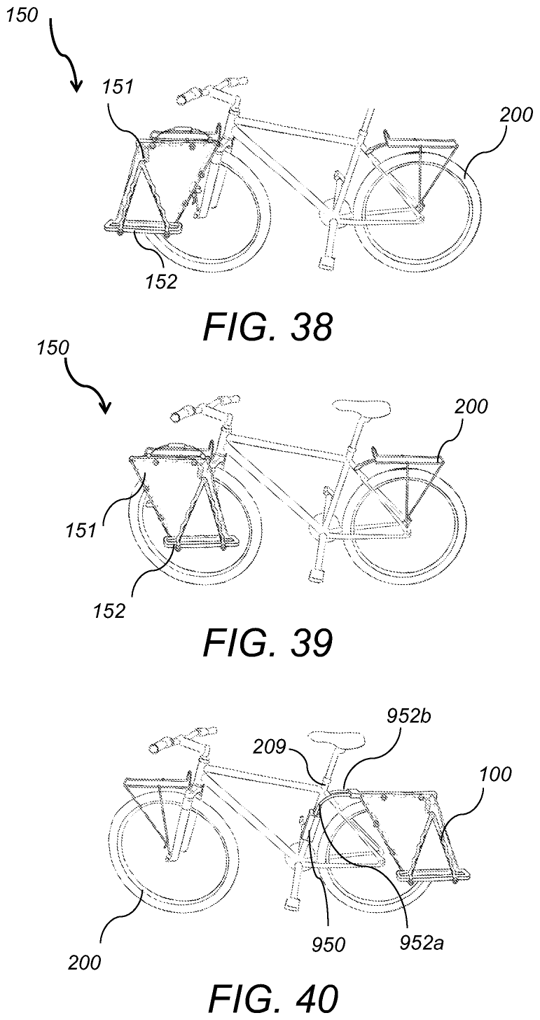

Referring to FIG. 2 and FIG. 3, the payload device 100 includes a back-section 101, a base 102, payload-securing components 103, and mounting-components 104. The payload-securing components 103 are used to secure the payload-bicycle 300 or other cargo objects to the payload device 100, and the mounting-components 104 are used to attach the payload device 100 to the host-bicycle 200. Back-section 101 is a trapezoid shaped planar board having a front surface 105a, a back surface 105b, a leading edge 106a, a trailing edge 106b, top edge 106c, and bottom edge 106d. When the payload device 100 is mounted to the side of the rear of the host-bicycle 200 the leading edge 106a is located proximal to the host-bicycle's center and the trailing edge 106b is located distal to the host-bicycle's center. In embodiments, where the payload device 100 is mounted to the side of the front of a host-bicycle the orientation can be either orientation, depending on the particular embodiment and the desired performance characteristics, as shown in FIG. 38 and FIG. 39.

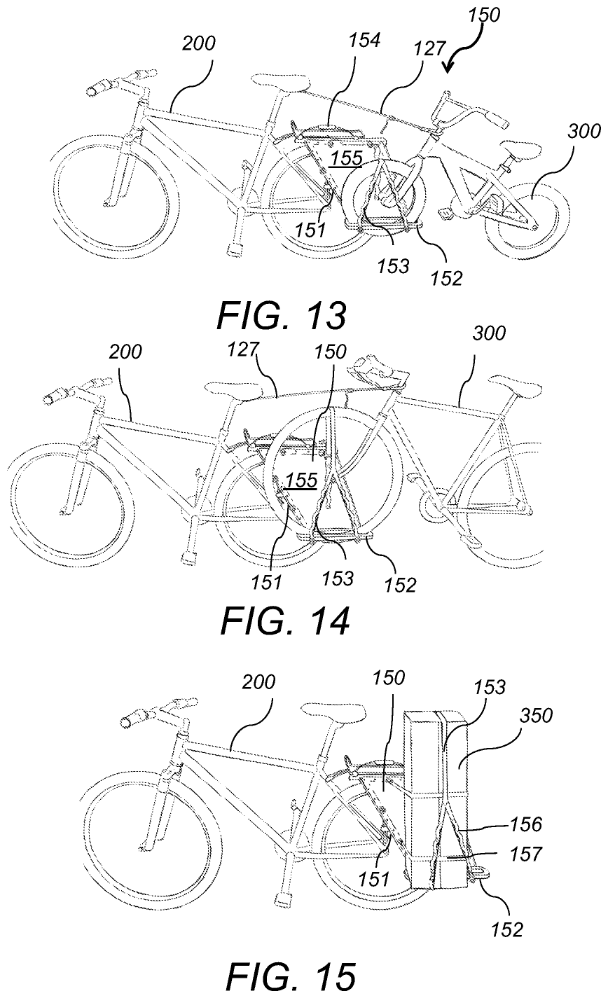

In the embodiment of FIG. 2 and FIG. 3, the leading edge 106a slopes towards the trailing edge 106b as it becomes more proximal to the base 102 and the trailing edge 106b slopes towards the leading edge 106a as it becomes more distal to the base 102. This geometric configuration of the back-section results in the bottom of the leading edge of the back-section and the leading edge of the base being offset relative to the top of the leading edge of the back-section. This offset provides sufficient clearance 88 between the leading edge of the base 102 and the pedal of the host-bicycle (when extended backwards) so that the front wheel of the payload-bicycle 300 that is mounted on the base does not interfere with the riding ability of the host-bicycle 200, as shown in FIG. 54. There is also sufficient clearance between the axle 207 of the rear wheel of the host-bicycle 200 and the leading edge of the bottom of the back-section. In one example, the back-section 101 typically measures 12″ inches to 23″ inches along the top edge 106c from the leading edge 106a to the trailing edge 106b, 10″ inches to 15″ inches along the bottom edge 106d from the leading edge 106a to the trailing edge 106b, and has a height from 14″ inches to 20″ inches from the bottom edge 106d to the top edge 106c. Due to the slope of the leading edge 106a, the bottom of the leading edge 106a is set back 6″ to 12″ inches from the top of the leading edge 106a. Back-section 101 is a structural component of the device 100 that transmits forces of payload to the mounting-components 104. In one example, the back-section 101 is made of plywood preferably ⅜″ to 1″ inches thick and has a weather protective coating such as paint, polyurethane, spar urethane or epoxy. In other examples, the back-section 101 is made of thicker or thinner materials as strength requirements may vary depending on the payload weight requirements of the device and depending on the desired cost of the device. In other examples, the back-section 101 is made of other materials such as plastic (e.g. HDPE) or sheet metal (e.g. aluminum or steel), and with each material the thickness can be adjusted as needed to provide the desired strength requirements. In other embodiments of the device 100, back-section 101 is constructed of a frame that may or may not be joined with a rigid or flexible sheet material such as sheet metal, plywood, vinyl, or canvas, as shown in FIG. 13, FIG. 14, and FIG. 15. In these embodiments, the frame of the back-section 101 is made of tubular metal such as steel, aluminum, or titanium, and may be hollow or solid, or it may be made of a plastic or wood. In these frame type embodiments of the back section 101, the sheet material, if present, can be thinner than the thickness of the board 105 of the embodiment of FIG. 2 that is made of a mono-material.

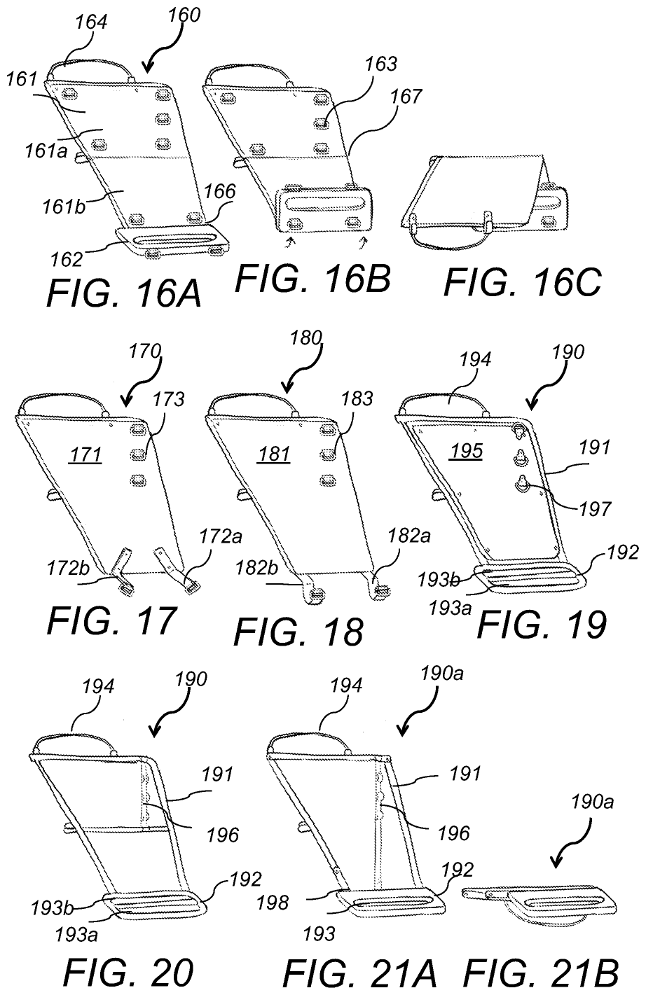

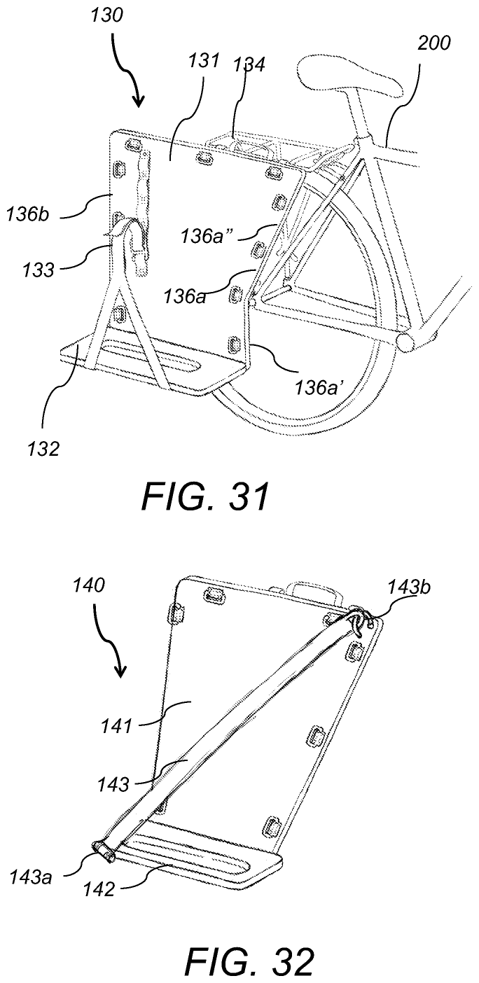

Base 102 is a planar and rectangular board and is mounted to the bottom side of the back-section 101. Top and bottom surfaces 102a, 102b of base 102 are parallel to the ground and the top surface 102a of base 102 is at an approximate geometric normal to the front surface 105a of the back-section 101. In one example, base 102 measures ½″ to 1″ inch thick. Leading edge 116a and trailing edge 116b of the base 102 are approximately flush with the bottoms of the leading edge 106a and trailing edge 106b of the back-section 101, respectively. The length on the front edge 116c of the base 102 that runs between the leading edge 106a and trailing edge 106b of the back-section 101 is typically from 10″ to 15″ inches long. In other embodiments, edge 116a and edge 116b is located further distal to base's center to provide a longer base for carrying a larger payload, as shown in FIG. 31. With such a longer base, edge 116a or edge 116b is cantilevered out beyond the leading edge 106a and trailing edge 106b of the back-section 101, respectively. In other embodiments, the leading edge 106a or trailing edge 106b of the back-section 101 are located further distal to the center of the back-section 101 to remain approximately flush with edges 116a or edge 116b, respectively. In yet other embodiments, the leading edge 106a or trailing edge 106 of the back-section 101 are located somewhere in between the cantilevered and flush locations. In one example, edge 116a and edge 116b measure 5″ to 8″ inches long. In other examples, edge 116a and edge 116b are longer to accommodate larger payloads. Base 102 further includes a slotted opening 115. In one example, slotted opening 115 measures 2.25″ wide and 10″ long, has rounded ends and is located with the proximal edge of the slotted opening 115 measuring 2.25″ from back-section 101. In other examples, the distance of the slotted opening 115 from the back-section 101 is longer than 2.25″ inches. This distance between the slotted opening 115 and the back-section 101 provides clearance for the front fork and front wheel axle of the payload-bicycle 300. In particular, for a payload bicycle 300 with wide tires (fat-bike), the distance of the slotted opening 115 from the back-section 101 is 2.5″ to 3.5″ inches. Slotted opening 115 is dimensioned to accept a wheel of the payload bicycle having a diameter ranging from nominal sizes 12″ to 29″ with tire widths up to nominal sizes 2.25″ wide. The actual wheel diameter size typically ranges from 10.5″ to 29.15″ (including the tire). In other examples, slotted opening 115 has a larger width to accommodate extra wide tires (such as 6″ or more for a fat-bike) or has longer or shorter lengths if targeted to work with subsets of the bicycle sizes on the market. In one example, the payload device 100 is designed exclusively for towing children's bicycles and the slotted opening has a shorter length of 5″ to 7″. In one example, base 102 is made of plywood with the same weather treatment as back-section 101. In other embodiments, base 102 is made of other materials such as plastic (e.g. HDPE) or sheet metal (e.g. aluminum or steel), and with each material the thickness can be adjusted as needed to provide the desired strength requirements. In one example, base 102 is affixed to the back-section 101 with stainless steel bolts or screws. In other examples, base 102 is made of other metals, possibly either inherently corrosion resistant or treated for corrosion resistance. In yet other examples, base 102 includes metal corner braces of stainless steel or other metals possibly with inherent or treated corrosion resistance. In embodiments that use frames for both the back-section 101 and base 102, the frames can be seamlessly built as a single frame with rolled tubing or welded or joined together by other means. Additionally in other embodiments of the device base 102 is rotatable and has a hinge or hinges between back-section 101 and base 102 such that the axis of rotation is at or near the shared edge between the two sections, as shown in FIG. 16. Such rotatable embodiments aid with foldability and storability of the device.

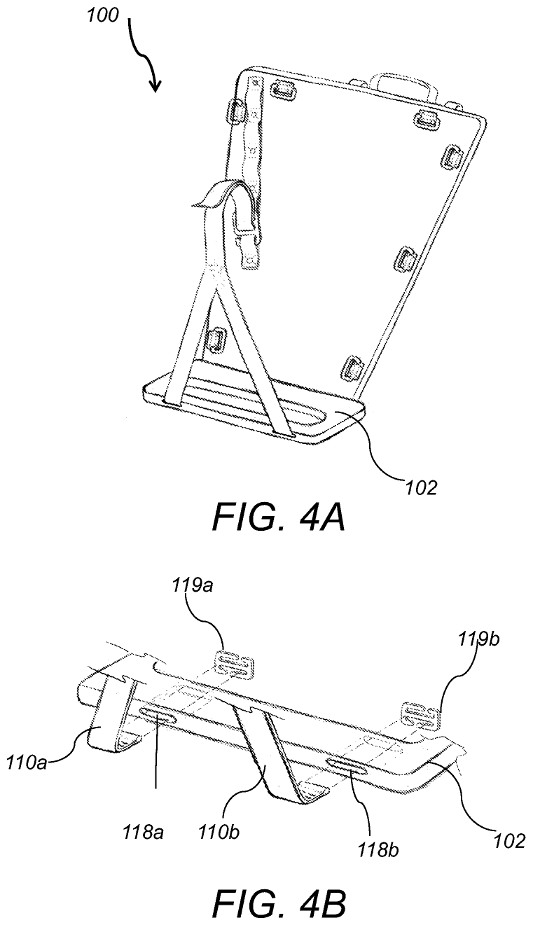

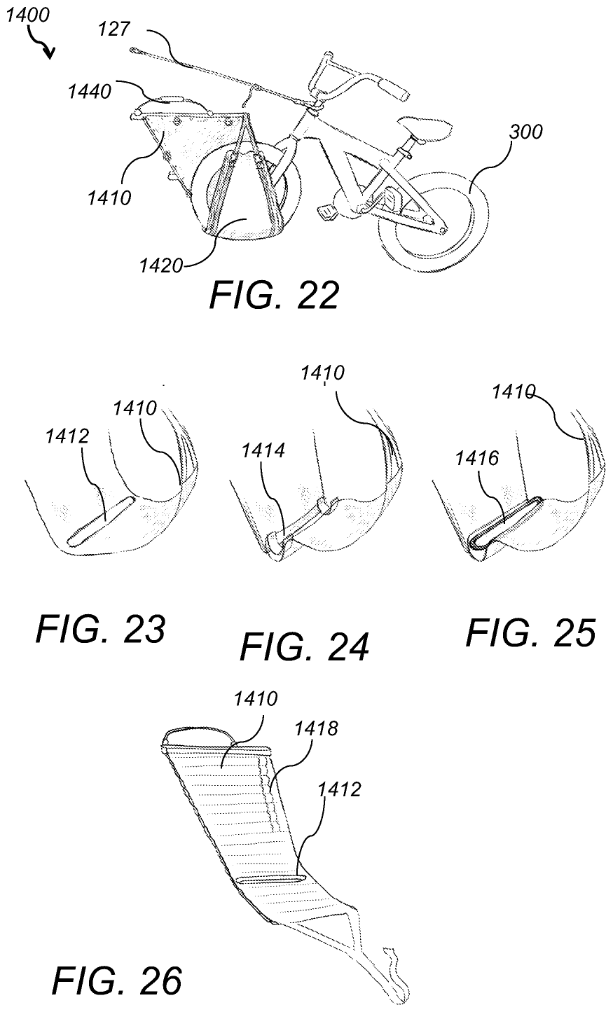

The payload-securing components 103 include a securing strap 110 and a securing strap anchor 108. The securing strap 110 and the securing strap anchor 108 function together to secure the wheel 302 of the payload-bicycle 300 into the slotted opening 115 and to prevent the wheel 302 from exiting the opening 115 during the perturbations of transit and additionally secure the wheel 302 from pitching side to side. Securing strap 110 splits into two straps components 110a and 110b towards the bottom end. Straps components 110a and 110b connect to base 102 at points 112a and 112b, respectively. The top end of the securing strap 110 is threaded through a G hook 113. The securing strap anchor 108 has numerous loops 114 along its length. The length of the securing strap 110 is adjusted for the wheel size of the payload-bicycle 300 by hooking the G hook 113 in the loop 114 of the securing strap anchor 108 that is closest to the top of the wheel 302 being secured to the device. By hooking G hook 113 to the loop 114 closest to the top of the wheel, the wheel pitch during transit is minimized. After a wheel is positioned in the slotted opening 115 and the securing strap 110 is adjusted by hooking G hook 113 into an appropriate loop 114, the exiting end 108a of the securing strap 108 is pulled to cinch the payload-bicycle's wheel 302 tight and securely into position. The securing strap 110 and securing strap anchor 108 are also used for securing a non-bicycle payload to the device. A payload can be additionally secured by using tie down anchors 107 that are located around the periphery of back-section 101. By using additional straps (not shown) with tie down anchors 107 (either in addition to securing strap 110 or instead of securing strap 110) a payload can be secured as needed. Different shapes and sizes of payload can be accommodated with the various straps and tie down anchors 107. In applications where the payload is another bicycle, tie down anchors 107 may be absent, as shown in FIG. 34. In one example, securing strap 110 and securing strap anchor 108 are made of nylon webbing. In other examples, securing strap 110 and securing strap anchor 108 are made of rubber, leather, solid plastic, metal chain, rope, among others. Securing strap anchor 108 is attached to the back-section 101 via stainless steel screws. In other examples, securing strap anchor 108 is attached to the back-section 101 via rivets, bolts, staples or adhesive. Referring to FIG. 4A and FIG. 4B, securing strap 110 has both ends 110a and 110b threaded through slots 118a, 118b, in the base 102 and secured to base 102 with 3 bar slides 119a, 119b at the termination of the webbing on the opposing side of the slots, respectively. In other embodiments G hook 113 and securing strap anchor 108 are substituted by dual side release buckles or a hook and hole. In yet other embodiments the securing strap 110 is substituted with a fabric sling (as shown in FIG. 22) or made instead with a rigid metal brace or braces that rotate to secure the wheel into place (as shown in FIG. 32). Furthermore, an elastic payload net can be attached to the tie down anchors 107 to secure many small loose items and irregular shaped large items (e.g. beach toys). Similarly, a fitted bag may be attached to the tie down anchors 107 or other fastening points to allow the device to function like an oversized pannier.

Mounting-components 104 include a loop handle 109, J-hooks 120a, 120b, a tension hook 122, a tension hook guide 123, and a bungee cord 124 attached to the back side 105b of back-section 101 via brackets 126a, 126b. Mounting-components 104 are located off center, towards the leading edge 106a of the device, as shown in FIG. 2 and FIG. 3. Mounting-components 104 mount the device 100 to a front or rear bicycle rack 201 that is mounted on a host-bicycle 200. The device 100 is mounted in a quickly attachable and quickly removable fashion. Handle 109 is used to lift the device 100 on to and off of the host-bicycle 200. J-hooks 120a and 120b hang the device 100 on a rail of the host-bicycle's rack 201 and function to transfer the weight of the payload-bicycle or payload from the device to the host-bicycle. J-hooks 120a and 120b are made of stainless steel and have a plastic coating to protect the host-bicycle's rack from scratching. In other embodiments, J-hooks are made of plastic, galvanized steel or aluminum, among others. J-hooks 120a and 120b have an inner diameter slightly larger than the tubing of the bicycle rack. In one example, J-hooks 120a and 120b have an inner diameter of 16 mm. J-hooks 120a and 120b may also have reducer shims inserted to accommodate 10 mm or 8 mm rack tubing. Additionally, other embodiments are built with slightly larger than 10 mm or slightly larger than 8 mm inner diameters for use specifically with a particular rack tubing size. J-hooks 120a and 120b are connected to back-section 101 by stainless steel screws. Alternatively, J-hooks 120a and 120b are connected to back-section 101 via rivets, bolts, adhesive, or welding.

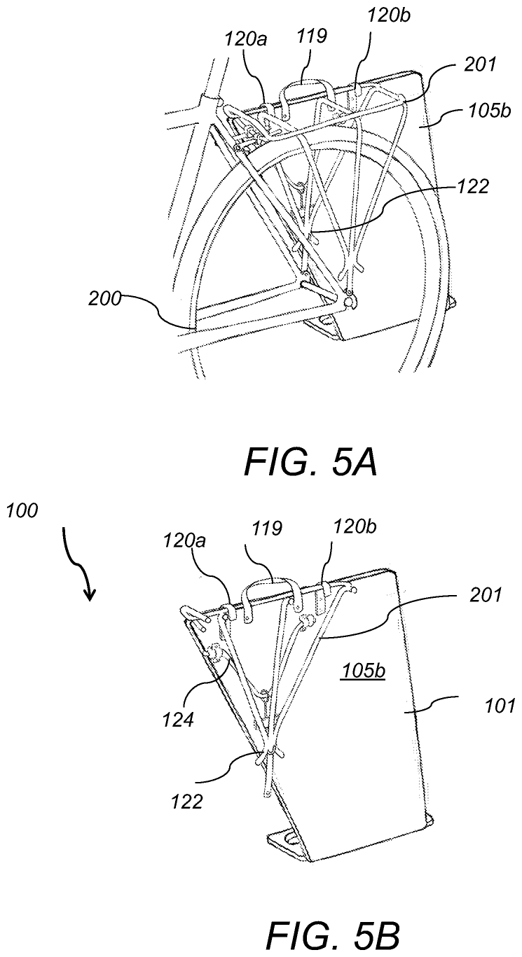

The tension hook 122 is used to secure the device 100 to the bottom of the host-bicycle's rack 201, as shown in FIG. 5A and FIG. 5B. The tension hook guide 123 constrains the motion of the tension hook 122, permitting the hook 122 to travel vertically up and down a large enough amount to connect and dismount the device and also limiting the travel horizontally towards the leading edge 106a or trailing edge 106b. The bungee cord 124 is threaded through a loop of the tension hook 122, and is affixed to the back-section 101 at each end via brackets 126a and 126b. The ends of the bungee cord 124 are tied into knots distal to the brackets. When tension hook 122 is secured around the host-bicycle's rack, bungee cord 124 is stretched to accommodate the dimensions of the rack. In doing so, it creates a tension force that prevents the device 100 from lifting high enough to unhook J-hooks 120a and 120b from perturbations during transit. FIG. 5A and FIG. 5B illustrate the device 100 mounted from the opposing side, to better illustrate the mounting-components in context. FIG. 5A shows the device mounted to a rear-bicycle-rack 201 with a host-bicycle 200 also in view. FIG. 5B shows the device mounted to a cutaway section of a rear-bicycle-rack 201 without the host-bicycle 200 in view, to further clarify the view of the mounting-components.

The device 100 can be mounted on either side of the rear bicycle rack 201. In this embodiment, the device has a chiral configuration built for the opposing side. In other embodiments the same device fits both sides, because it has features that adjust (e.g. flip or rotate) and/or a geometry that has a single achiral design that fits on both sides of the front or rear host-bicycle rack. Relative to the center of the host-bicycle 200, on a standard sized rear bicycle rack 201 the top edge 106c of the back-section 101 is cantilevered distally, extending along the axis of the rail of the bicycle rack 201, by roughly 0″ to 10″. On a front bicycle rack the top edge of the device can also be cantilevered distally, along the axis of the rail of the bicycle rack, as shown in FIG. 38 and FIG. 39. The base 102 is also located partly beyond the rear bicycle rack 201, distal to the center of the host-bicycle 200, along an axis parallel to the axis of the rail of the bicycle rack. In the embodiment of FIG. 1, leading edge 116a of the base 102 of the payload-device 100 is located at a setback 89 in the range of 2″ to 5″ behind the rear wheel's axle 207 of the host-bicycle 200. This setback and the cantilevered location of the base provide adequate clearance for the rider's heel while pedaling the host-bicycle 200, so that the rider's heel will both clear the device and a payload-bicycle 300 of any size. A child sized bicycle's front wheel is substantially smaller than an adult sized bicycle, and requires much less clearance, and hence an embodiment of the device that tows only children's sized payload-bicycles can have substantially less setback in its dimensions. In such an embodiment, the setback 89 of edge 116a can be 0″ or even slightly negative (a negative value would be proximal of the rear axle). In this embodiment, the front wheel of an adult sized payload-bicycle 300, when secured to a host-bicycle 200 via device 100, is approximately located geometrically tangent to the edge of the seat stays of the host-bicycle 200. The dimensions of the device 100, are proportioned to accommodate such a position. This position is approximate, and depends on the particular geometry of the host-bicycle 200. Some host-bicycles have a lot of space between the rider's heel and the axle of their rear wheel. Examples are cargo bicycles, longtail bicycles, bakfiets, workcycles, and Dutch style bicycles. Furthermore, extra long rear bicycle racks can be purchased for host-bicycles that enable the device to be mounted further rearward on the bicycle. For such host-bicycles that have extra clearance behind the rider's heel and the device, the setback 89 of the edge 116a is not necessary. Embodiments of the device built for such host-bicycle scenarios do not have a setback and might not be cantilever off the host-bicycle's rack.

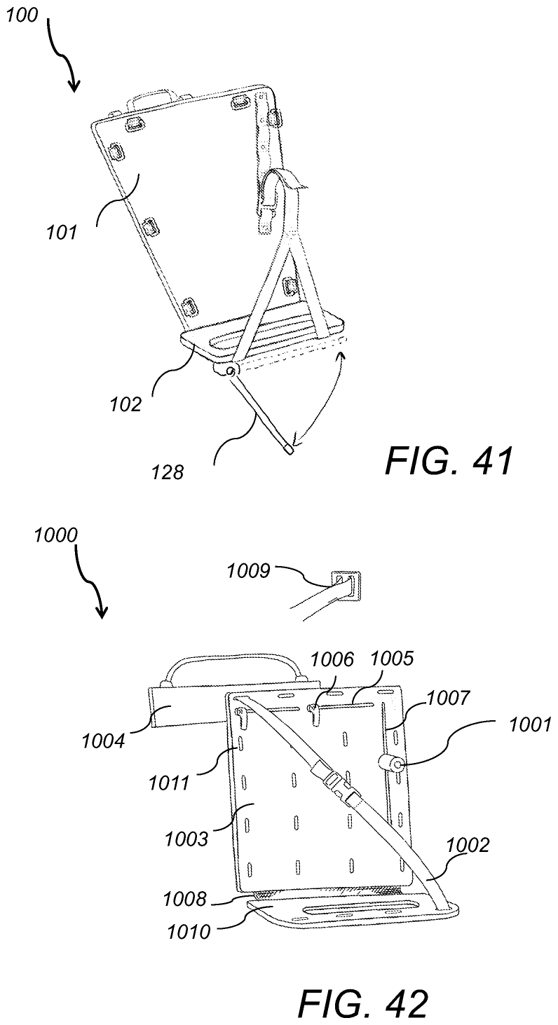

In some embodiments, device 100 includes an integrated stabilizer support 128, as shown in FIG. 41. The stabilizer support 128 can help to stabilize the host-bicycle while loading and unloading the device's payload, or while riding with a payload. Support 128 can have various forms. The support may take the form of a kickstand that can be lowered and raised as needed. Additionally, it can take the form of a wheel or wheels. As a wheel or wheels, the integrated stabilizer support can maintain contact with the ground while the host-bicycle is ridden.

Referring back to FIG. 1, the payload-bicycle 300 is further supported by a tip-prevention-strap 127. The tip-prevention-strap 127 prevents the payload-bicycle 300 from falling during turns of small radius during towing while being towed by its front wheel. It also functions as a redundant way to secure the payload-bicycle 300 to the host-bicycle 200 in case of failure of a part of the device. During a turn in transit, the frame of the payload-bicycle 300 rotates about its head tube, while its front fork, handlebars, and front wheel remain oriented with the device 100 and with the host-bicycle 200. During a small radius turn, the frame of payload-bicycle 300 can rotate enough that it begins to orient along the axis geometrically normal to the plane of the front wheel, at which point it is liable to pitch over onto its side by rotating about the axis of the axle of its front wheel. The tip-prevention-strap 127 geometrically constrains the pitch of the frame of the payload-bicycle 300 during the small radius turn to maintain an appropriate position for towing. The tip-prevention-strap 127 is adjustable in length and has ends that can be secured on one end to the payload-bicycle 300 and on the other end to the device 100 or to a part of the host-bicycle (including the rear bicycle rack 201) such as the seat post or saddle rail. In one example, the tip-prevention-strap 127 is connected to the stem on the payload-bicycle 300, as shown in FIG. 1. The tip-prevention-strap 127 can be inelastic or elastic, but if it is elastic in nature, it must have strain within a certain tolerance and not have so much strain under working loads that it can not perform its function described herein. The tip-prevention-strap 127 has enough slack or elasticity to permit the unmounted wheel of the payload-bicycle 300 to roll on the ground when the host-bicycle 200 is riding over typical terrains. The tip-prevention-strap 127 accommodates riding along an arch (such as over a speedbump) with both wheels of the host-bicycle 200 and the rolling wheel of the payload-bicycle 300 simultaneously maintaining contact with the ground. The tip-prevention-strap 127 is made of nylon webbing, plastic, leather, or bungee cord, or a combination of these materials, with carabiner clips on the ends. Many other embodiments of the tip-prevention-strap 127 exist that use other materials or configurations. Other materials include rope and chain. Different kinds of termination in place of the carabiner clips can be used that allow it to secure to the host-bicycle 200 and the payload-bicycle 300. The tip-prevention-strap 127 even need not be a strap at all, and it need not connect to the stem of the payload-bicycle 300. For example, in another embodiment, a metal brace or a rubber bumper 1001 is mounted on the back-section 101 that constrains the front fork of the payload-bicycle 300 from rotating significantly about the axis of the payload-bicycle's front wheel axle while it's mounted in the device, as shown in FIG. 42. The tip-prevention-nub 1001 can be adjusted in height along a vertical track to fit different sized front forks of payload-bicycles.

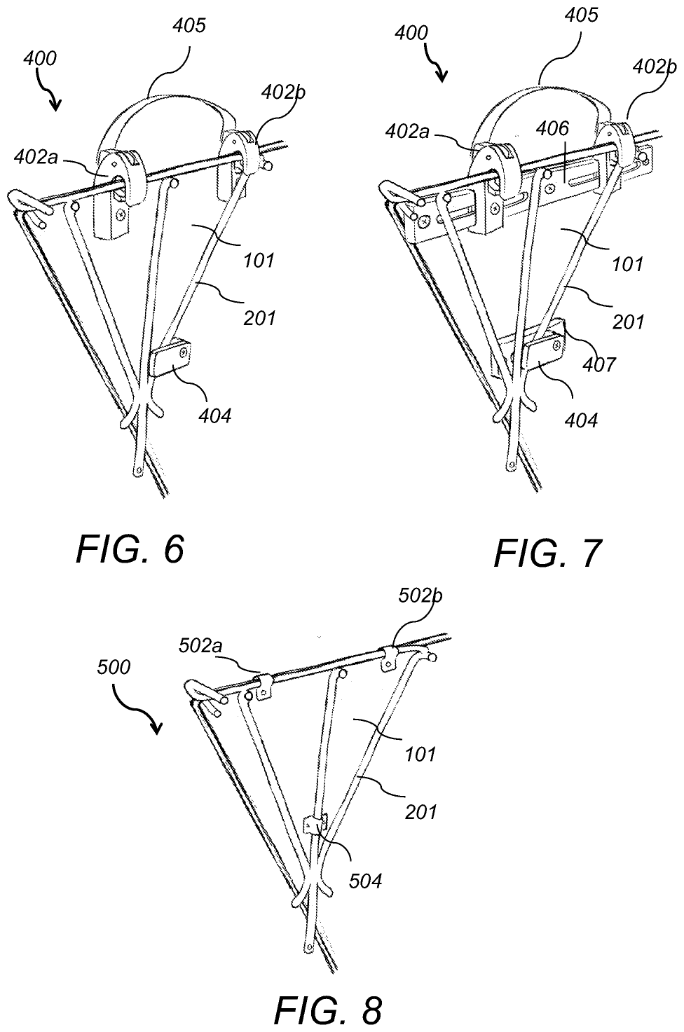

FIG. 6, FIG. 7, FIG. 8 illustrate embodiments of the device, that are otherwise identical to the embodiment of FIG. 2 and FIG. 3 except for different mounting-components. FIG. 6, FIG. 7 and FIG. 8 depict cutaways of the upper leading edge region of the device 100 and a cutaway of one side of the rear-bicycle-rack 201. In FIG. 6, the mounting components 400 include a handle 405, latches 402a and 402b, and a catch 404. The ends of handle 405 are attached to the latches 402a, 402b. Pulling the handle 405 opens the latches 402a and 402b, and allows the device to be released and lifted from the bicycle rack 201 in a single motion. When the handle 405 is released, the latches 402a and 402b spring closed to lock the device onto the bicycle rack 201. Catch 404 slides around the opposite side of the rack's support to prevent the device 100 from rotating about the latches on the rack's rail. The handle 405 is made of nylon webbing, although other materials can be used instead, such as leather or plastic, and is screwed or riveted to the latches 402a and 402b. The latches 402a and 402b are primarily made of plastic or metal, and can be injection molded, cast, or milled. They are composed of small latch parts, springs, and axles in addition. Latches 402a and 402b and catch 404 are all screwed to the back-section 101 with stainless steel screws, but may also be connected with rivets, adhesive, or by other means.

In FIG. 7, the mounting components 400 include a handle 405, latches 402a and 402b, a catch 404, a latch-rail 406 and a catch-rail 407. In this mounting embodiment the latches 402a, 402b and the catch 404 are mounted to the rails 406 and 407, respectively, and the rails 406, 407 are in turn mounted to the back-section 101. The latches 402a and 402b and the catch 404 can slide along the rails 406 and 407, respectively, and are set in position with screws. These two rails 406, 407 allow the positions of the latches 402a and 402b and the catch 404 to be easily adjusted on the device to better accommodate varying rack geometries. The latch-rail 406 and the catch-rail 407 are made of injection molded plastic, but they can be made of other materials and with other methods such as milled plastic, cast metal, or milled metal.

In FIG. 8, the device 100 is permanently mounted to the bicycle rack 201 and the mounting components 500 include brackets 502a, 502b, and 504 that are secured around the rear-bicycle-rack 201's rail and support. The brackets 502a, 502b, and 504 are made of stainless steel and are screwed to the device's back-section 101. Alternatively, brackets 502a, 502b, and 504 are made of other materials such as other metals or plastic, and can be connected by other means or materials such as by rivet.

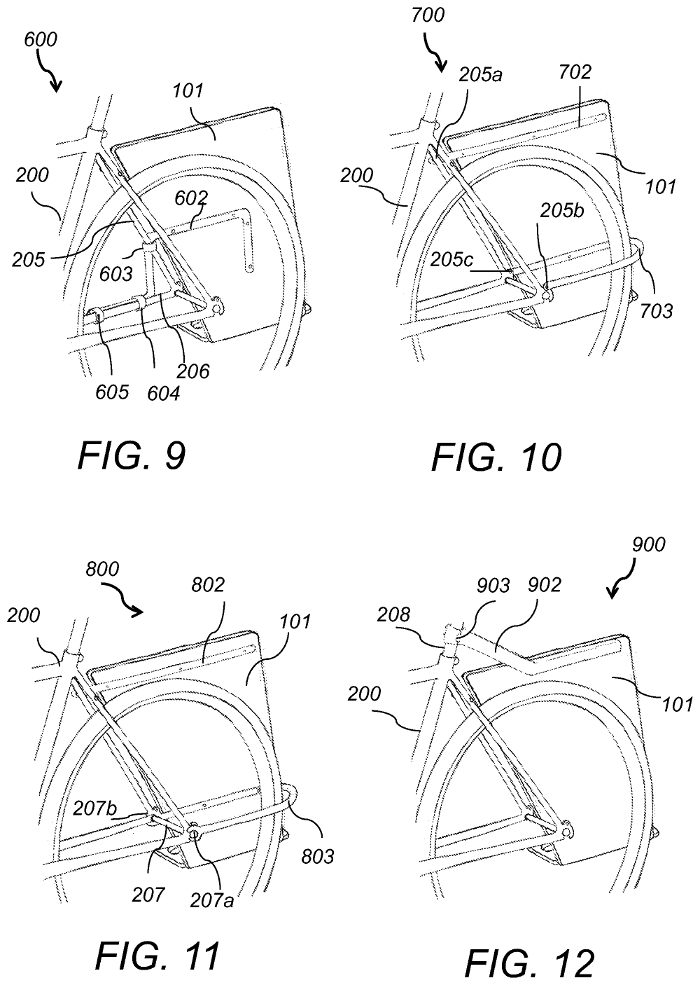

FIG. 9, FIG. 10, FIG. 11 and FIG. 12 illustrate embodiments of the device, that are otherwise identical to the embodiment of FIG. 2 and FIG. 3 except that they mount directly to the host-bicycle 200 and do not involve a bicycle rack. FIG. 9, FIG. 10, FIG. 11 and FIG. 12 depict cutaways of the upper leading edge region of the device 100. In FIG. 9, the mounting components 600 include a mounting-bar 602, which is connected to the back-section 101 of the device 100, and is mounted to the bicycle 200 on the seat stay 205 with mount 603 and on the chainstay 206 with mount 604 and mount 605. In FIG. 10, the mounting components 700 include a mounting-bar 702 and a mounting-U-bar 703. Mounting bar 702 is connected to the back-section 101 and is connected to the bicycle 200 with machine screws at the upper seat stay eyelet 205a. The mounting-U-bar 703 is also connected to the back-section 101 and is connected to the bicycle 200 with machine screws at the rear dropout eyelets 205b, 205c. In FIG. 11, the mounting components 800 include a mounting-bar 802 and a mounting-U-bar 803. The mounting-bar 802 is connected to the back-section 101 and is mounted to the bicycle 200 with a machine screw at an upper seat stay eyelet 205a. The mounting-U-bar 803 is also connected to the back-section 101 and is mounted on the rear wheel axle 207 and secured by the axle nuts 207a, 207b. Alternatively, the mounting-U-bar 803 is secured by adjusting a nut and a cam of a quick release mechanism. In FIG. 12, the mounting components 900 include a mounting-bar 902, which is connected to the back-section 101 and is attached to the bicycle 200 on the seat tube 208. Mounting-bar 602, mounting-U-bar 703, and mounting-U-bar 803, are made of bent hollow tubing of painted steel or aluminum. Alternatively, mounting-bar 602, mounting-U-bar 703, and mounting-U-bar 803 are made of other materials and with other fabrication techniques as well, such as solid aluminum or injection molded plastic. Mounting-bar 702 and mounting-bar 802 are made of steel or aluminum bar stock. Alternatively, mounting-bar 702 and mounting-bar 802 are made of other materials and forms, such as hollow steel tubing or plastic hollow extrusion. Mounting-bar 902 is made of aluminum box extrusion with a welded angle joint, and has a welded clasp 903 to connect to the seat post 208. Alternatively mounting-bar 902 is made of other materials and forms as well. All the mounting-bars and mounting-U-bars are secured to the back-section 101 by stainless steel screws or other fastening means such as rivets or adhesives.

In some embodiments, the device 100 is mounted to a host-bicycle 200 without the use of the mounting-components 104. Referring to FIG. 40, the device 100 is mounted to a host-bicycle 200 with a frame-bracket 950 that permanently clamps onto the seat tube 208 of the host-bicycle 200. This frame-bracket 950 has two receptacles for two pieces of tubing 952a, 952b, which run from the frame-bracket 950 to the top of the back-section 101 of the device 100. The frame-bracket 950 has catches that catch and release the frame-tubing 952a, 952b, such that the tubing may be quickly removable from the frame-bracket by the push of a release button. The tubing 952a, 952b is typically made of steel and the bracket 950 is typically made of injection molded plastic, although other materials may be used in their places. The mechanics for the catches are made with a mix of small pieces of metal and/or plastic.

Referring to FIG. 13, FIG. 14, and FIG. 15, in another embodiment, payload device 150 includes a back-section 151, a base 152, payload-securing components 153, and mounting-components 154. In this embodiment, the back-section 151 is a frame of metal tubing that is load bearing and transfers the forces of the payload 350 or payload-bicycle 300 to the host-bicycle 200. In this embodiment the back-section also has a sheet material 155 connected to the frame 151. Sheet 155 is made of a flexible material, such as nylon fabric. Alternatively, sheet 155 is a thin solid sheet material such as sheet of metal, plastic, or plywood. In this embodiment, the sheet material 155 of the back-section does not need to be load bearing since the frame 151 is load bearing. The securing-strap 153 has loops 156 along its length, through which other straps 157 are threaded to securely attach payloads 350, as shown in FIG. 15. FIG. 13 shows a children's bicycle with 16″ wheels as a payload-bicycle 300. FIG. 14 shows an adult bicycle with 700c wheels as a payload-bicycle 300. FIG. 13 and FIG. 14 illustrate that the device accommodates the different geometries of an adult payload-bicycle and a child's payload-bicycle, and it can be seen that the wheels of the payload-bicycle occupy different areas of the device. FIG. 15 depicts a large box 350 as a payload, and illustrates the use of the base 152 as a shelf to rest the edge of the payload. It additionally illustrates the use of payload-securing-components 153 in conjunction with tie down anchors being used to secure the payload. The large box 350 hangs beyond an edge of the base of the device, and yet is securely carried by the device.

Referring to FIG. 16A-FIG. 16C, the payload device 160 includes a back-section 161 and a foldable base 162. The bottom edge of the back-section is connected to the back side 166 of the base 162 with hinges which enable the base to be folded for storage and for transport. In this embodiment, the back-section includes an upper portion 161a and a separate lower portion 161b. Portions 161a, 161b are connected with hinges and are foldable along line 167. FIG. 16A-FIG. 16C show the device in three different states: deployed, partially folded, and completely folded, respectively. In this embodiment, tie down anchors 163 are used to connect to the payload-securing-straps (not shown).

Referring to FIG. 17, the payload device 170 includes a back-section 171 and angled supports 172a, 172b instead of a base. Tie down anchors 173 are used to connect to the payload-securing-straps (not shown). In FIG. 18 the payload device 180 includes a back-section 181 and swooped U-shaped supports 182a, 182b, instead of a base. The secured wheel of the payload-bicycle rests in the U-shaped portion of the two supports 182a, 182b. Tie down anchors 183 are used to connect to the payload-securing-straps (not shown).

Referring to FIG. 19, the payload device 190 includes a single frame of metal tubing forming the back-section 191 and base 192. The single frame of metal tubing is load bearing and transfers the forces of the payload 350 or payload-bicycle 300 to the host-bicycle 200. Additionally, the back section 191 includes a sheet material 195 connected to the frame. Sheet material 195 is a flexible material, such as nylon fabric. Alternatively, sheet material 195 is a thin solid sheet material such as sheet metal, plastic or plywood. In this embodiment, the sheet material 195 of the back-section does not need to be load bearing since the frame is load bearing. The base portion 192 of the frame has two openings 193a, 193b. Either opening 193a, 193b is designed to accept the wheel of the payload-bicycle 300. Alternatively, the base portion 192 of the frame is shaped as a rectangular shape with a single opening and covered with plywood (or another material) with a slotted-opening. In FIG. 20 the payload device 190 includes a single frame of metal tubing forming the back-section 191 and base 192. In this embodiment, there is not a sheet material in the back-section 191. A securing strap anchor 196 mates with the payload-securing-straps (shown in FIG. 15) to secure the payload 350 to the base 192. In FIG. 21A, and FIG. 21B the payload device 190a includes a single frame of metal tubing forming the back-section 191 and a rectangular board base 192 having one slotted opening 193. In this embodiment the back-section 191 and base 192 are connected via hinge points that enable it to fold for storage or for transport along the common edge 198. FIG. 21A depicts the payload device 190a in the deployed state and FIG. 21B depicts the payload device 190a in the folded state.

Referring to FIG. 31, the payload device 130 includes a back-section 131, a base 132, payload-securing components 133, and mounting-components 134. Device 130 is mounted to a host-bicycle 200 and a portion of the host-bicycle 200 is cut away for clarity. In this embodiment the base 132 and back-section 131 are larger than the base 102 and back-section 101 of the embodiment of FIG. 2. The larger size base 132 and back-section 131 allow the device 130 to carry larger payloads. Both the trailing edge 136b and the bottom portion 136a′ of the leading edge 136a of the back-section 131 are vertical, which creates a larger area for securing payloads. The back-section 131 measures 20″ tall, 19″ to 23″ on the top edge, and 12″ to 16″ at the bottom edge, and cantilevers off of the bicycle rack by roughly 6″ to 10″. The base 132 is longer to match the back-section 131 and measures 12″ to 16″ in length and 6″ to 11″ in depth.

FIG. 32 depicts an embodiment of the payload device 140 where the securing strap 110 and securing strap anchor 108 of the embodiment of FIG. 2 are replaced with a rigid or semi-rigid brace 143 used to secure the wheel of the payload-bicycle. The brace 143 rotates about the bottom end 143a and latches closed at the top end 143b. Brace 143 is made of plastic, metal, or wood.

Referring to FIG. 42, another embodiment of the payload device 1000 includes a back-section 1003, a base 1010, payload-securing components 1002, and mounting-components 1004. Back-section 1003 and base 1010 include integrated features 1011, 1007, 1005. This design can be manufactured by a Computer Numerical Control (CNC) milling machine and CNC water jet cutter, as well as by hand or by other manufacturing techniques. The back-section 1003, base 1010, and mounting bar 1004 are made of rigid or semi-rigid material, such as plywood, metal, or plastic. The features 1011, 1007, 1005 are simple and integrated into these sections. In one example, features 1007 and 1005 are tracks and features 1011 are slots. A cam lever fastener 1006 slides in the track 1005, allowing the position of the mounting bar 1004 and 1003 to be adjusted to change the cantilever distance of the device. A tip-prevention-nub 1001, similarly slides in track 1007 and locks via a cam lever fastener located on the rear side of the back-section 1003. The tip-prevention-nub 1001 can be adjusted to fit under the front fork of the payload-bicycle 300 to prevent that bike from tipping during small radius turns. In this embodiment of the invention, back-section 1003 and base 1010 are connected via a flexible hinge 1008 which is made of various materials or configurations such as nylon webbing, leather, or piano hinge. The securing-strap 1002 runs diagonally across the device to secure the front wheel of a payload-bicycle. It also provides tension to support the base 1010 when it has a payload. Without a payload in the device, the base 1010 can be folded closed by tightening the securing-strap 1002. Back-section 1003 and base 1010 have numerous anchor-slots 1011 within them. These anchor-slots 1011 serve as an open ended platform for connecting to these parts. Anchor-slots 1011 accept the securing-strap 1002, webbing terminated by a 3 bar slide 1009, webbing straps without 3 bar slides that are run through the slots, bungee cords with a J-hook terminus, among others. A tension hook 122 or catch 404 is mounted to the rear of the back section 1003. Alternatively, tension hook 122 or catch 404 is mounted to the anchor-slot 1011. The design of this embodiment allows for the same parts to be used for the chiral configuration, and for a user to reconfigure their device for the chiral configuration as needed.

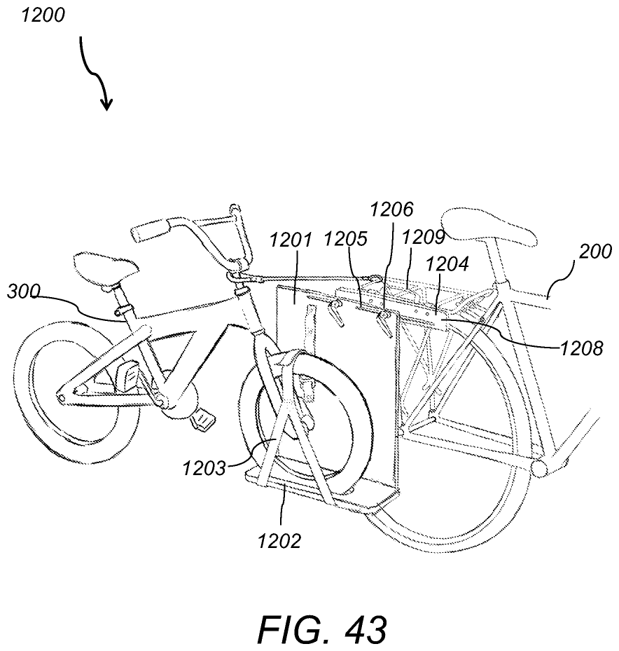

Referring to FIG. 43, in yet another embodiment of the invention, the payload device 1200 includes a back-section 1201, a base 1202, payload-securing components 1203, and mounting-components 1208. Back-section 1201, base 1202, and payload-securing components 1203 are similar to the corresponding components in FIG. 2. Mounting components 1208 include a mounting bar 1204 and a handle 1209. The position of the mounting bar 1204 is adjusted relative to the back section 1201 by sliding two cam lever fasteners 1206 along tracks 1205. This change of the position of the mounting bar 1204 relative to the back section 1201 changes the cantilever distance of the device.

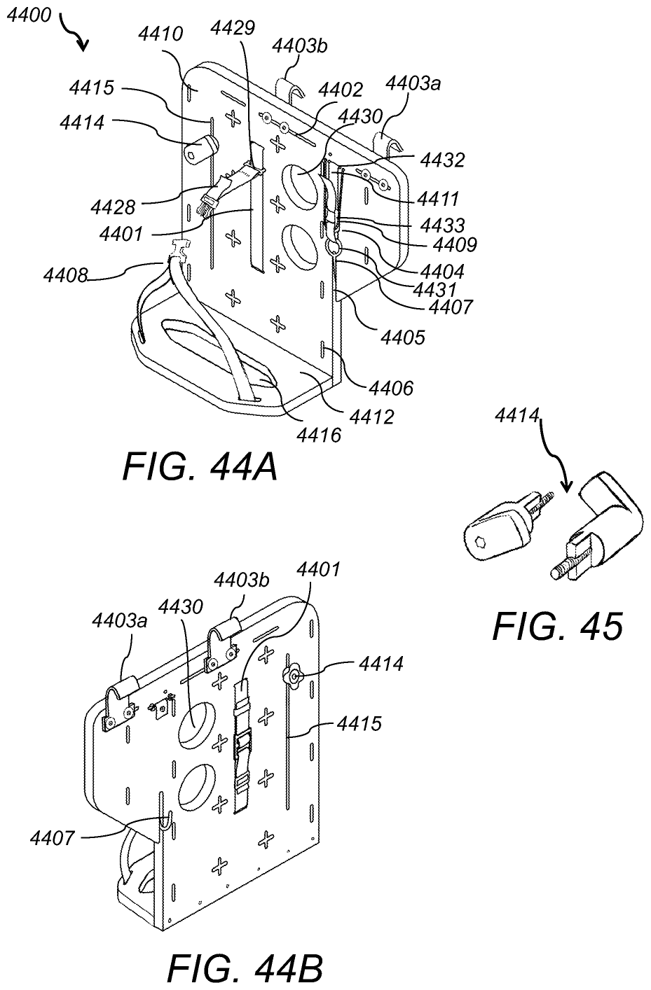

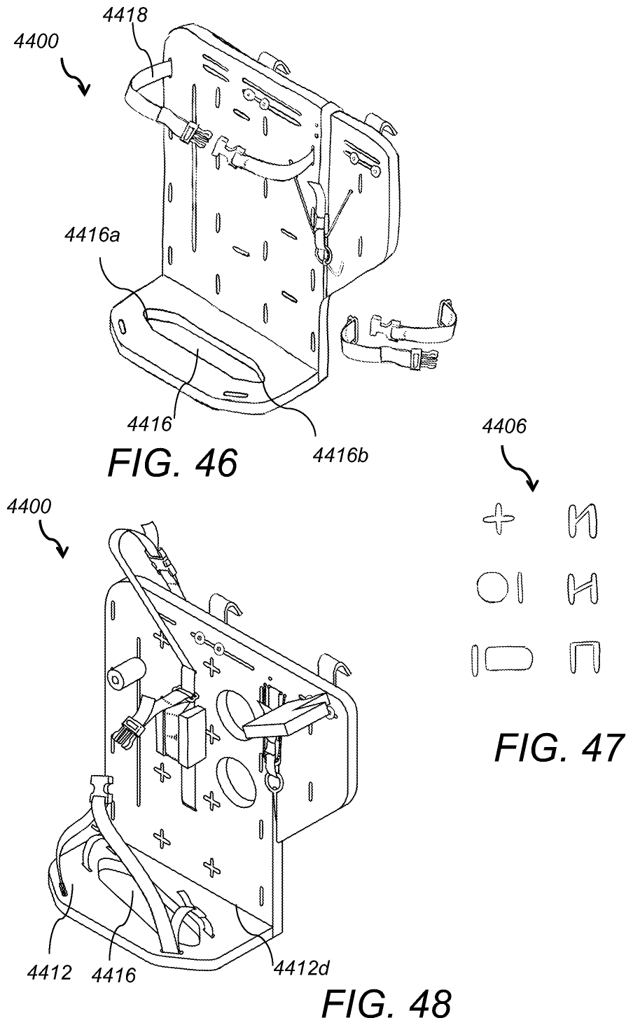

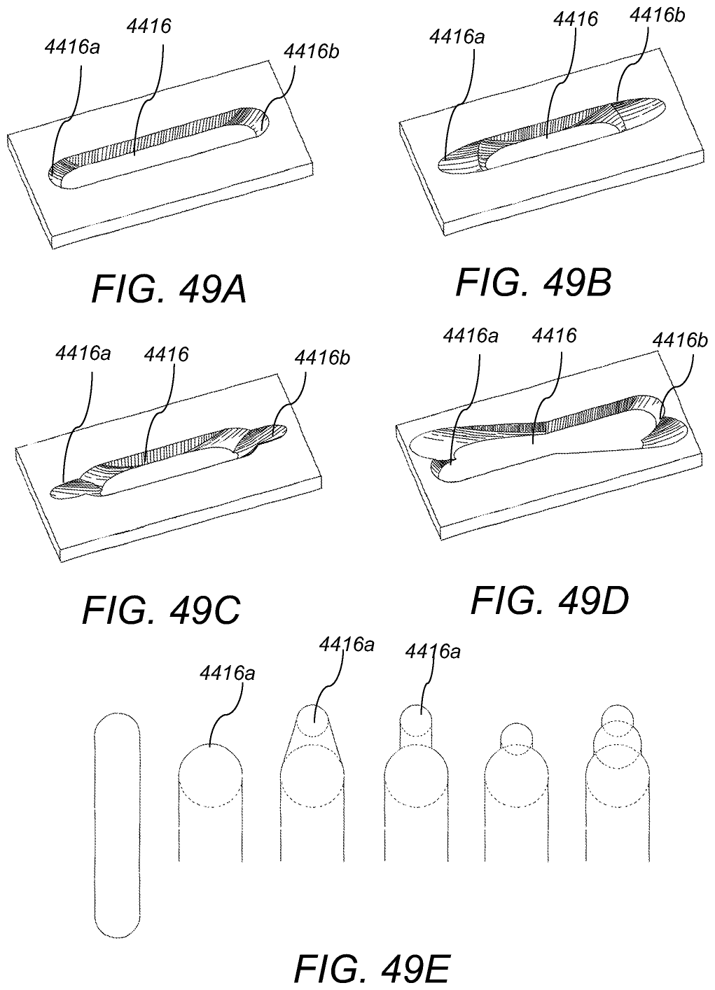

Referring to FIG. 44A, FIG. 44B, FIG. 45, FIG. 46, FIG. 47, FIG. 48, and FIG. 49A-FIG. 49E, in yet another embodiment of the invention, the payload device 4400 includes a back-section 4410, a base 4412, payload-securing components 4408, and mounting-components 4404. Back section 4410 includes anchor slots 4406, hook slots 4402, openings 4430, securing straps 4408, J-hooks 4403a, 4403b, and mounting components 4404. Anchor slots 4406 and tracks 4402 have multiple orientations including horizontal, vertical, diagonal, among others. In other embodiments, anchor slots 4406 may have one of the six anchor slot patterns depicted in FIG. 47, including cross-shaped, H-shaped, circular, oval, rectangular, π-shaped, or combinations thereof, among others. The securing-strap 4428 is terminated with a 3 bar slide 4429 that slides vertically along the securing-strap-slide-anchor 4401. In other embodiments, the securing strap is a horizontal mountable strap 4418, as shown in FIG. 46. J-hooks 4403 are mounted along hook-slots 4402. These hook-slots 4402 provide a degree of freedom, allowing many potential positions for the J-hooks 4403 to be positioned. This payload device 4400 can also be mounted to the host-bicycle 200 with p-clamps or other kinds of connectors. The mounting-components 4404 are notably positioned on the front side of the back-section 4410. The tension hook 4407 passes through a vertical slot 4405 that serves as a tension hook guide and is tensioned with a bungee tensioner 4409. Webbing 4411 runs from the backside of the back-section 4410 to the frontside through a slot 4432 and is threaded through a cam-buckle 4433. The cam-buckle 4433 then connects to a ring 4431 of the tension hook 4407 via a short loop of webbing. The cam-buckle 4433 constrains the vertical descent of the tension hook 4407 unless released. This embodiment also includes a fork-catch 4414, (also illustrated in isolation in FIG. 45), which is similar to the tip-prevention-nub of embodiment of FIG. 42. The fork-catch 4414 has an elbow shape and can be positioned vertically along a fork-catch slot 4415. Back-section 4410 also includes openings 4430 that allow a user to reach through from the frontside to the backside and to release the securing straps 4418 when the payload-bicycle is mounted to the host-bicycle. Base 4412 includes a slotted opening 4416 that has V-shaped ends 4416a, 4416b, with a smaller radius measuring ˜0.5″ at the tip of each “V”, and a larger radius measuring about 1.125″ at the arcs that join each side of the “V”s to the long edges of the slotted opening 4416. In other embodiments, slotted opening 4416 has ends 4416a, 4416b, that are semi-circular, circular, oval, rectangular, linear, elongated, heart-shaped vertical walled, 3-dimensional contoured, or combinations thereof, as shown in FIG. 49A-FIG. 49E. In some embodiments, slotted opening 4416 is oriented at angle relative to the back edge 4412d of the base 4412, as shown in FIG. 48.

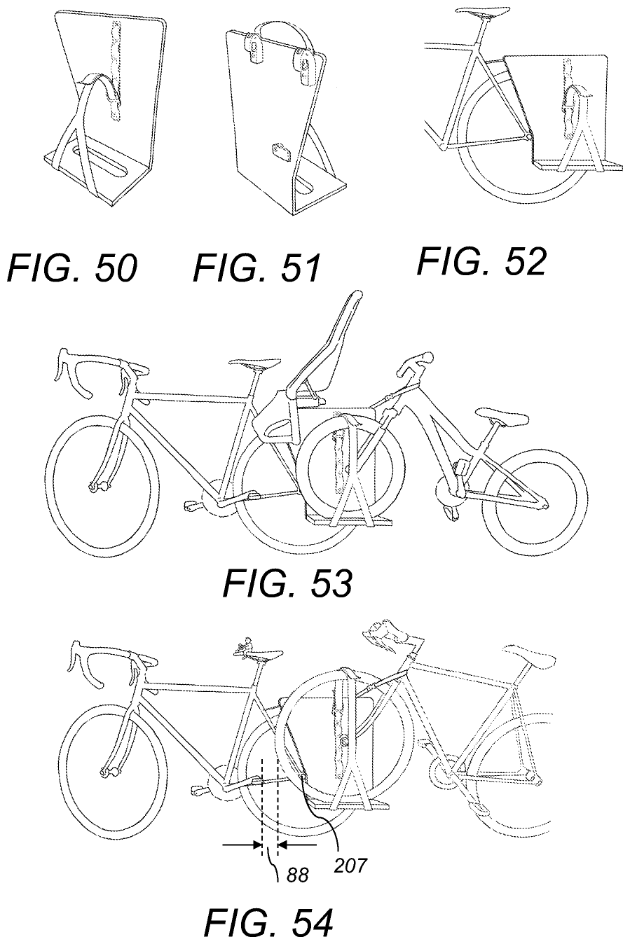

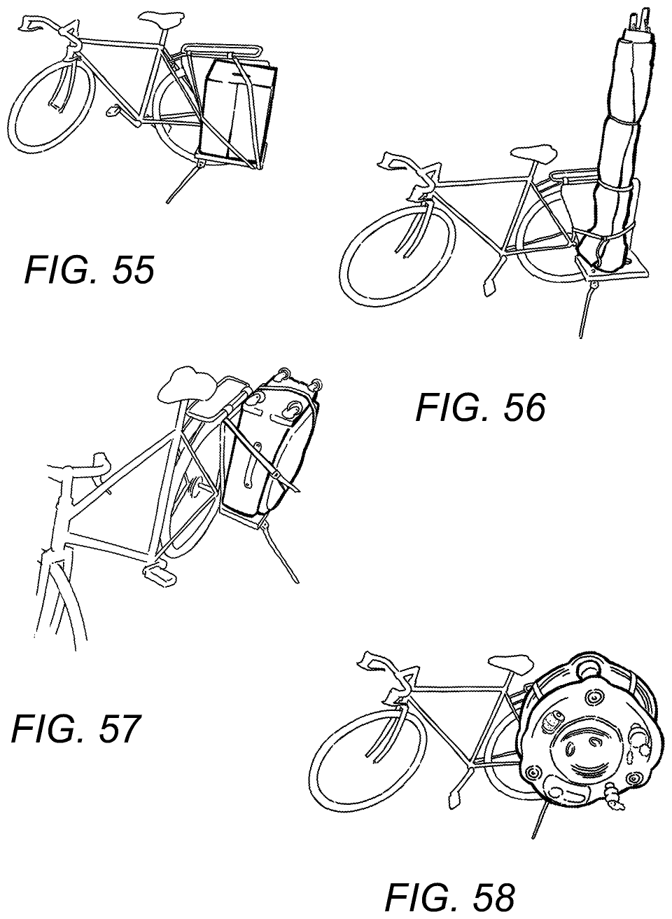

FIG. 50, FIG. 51, FIG. 52, FIG. 53, FIG. 54, FIG. 55, FIG. 56, FIG. 57, and FIG. 58 depict an implementation of the embodiment of FIG. 31 in use. Various securing strap configuration and parts are used to accommodate the various payloads. FIG. 50 depicts the front side view of the implementation of the embodiment of FIG. 31. FIG. 51 depicts the rear side view of the implementation of the embodiment of FIG. 31. FIG. 52 depicts the implementation of the embodiment of FIG. 31 mounted on a rear rack of a bicycle. FIG. 53 depicts the implementation of the embodiment of FIG. 31 mounted on the rear rack of a bicycle, with a child's bicycle with 16″ wheels as a payload-bicycle. FIG. 54 depicts the implementation of the embodiment of FIG. 31 mounted on the rear rack of a bicycle, with an adult bicycle with 700c wheels as a payload-bicycle. FIG. 55 depicts the implementation of the embodiment of FIG. 31 mounted on the rear rack of a bicycle, with a loaded cardboard box of approximately 25 lbs as a payload. FIG. 56 depicts the implementation of the embodiment of FIG. 31 mounted on the rear rack of a bicycle, with a large rolled hammock as a payload. FIG. 57 depicts the implementation of the embodiment of FIG. 31 mounted on the rear rack of a bicycle, with a carry-on suitcase as a payload. FIG. 58 depicts the implementation of the embodiment of FIG. 31 mounted on the rear rack of a bicycle, with an infant jumper as a payload.

Referring to FIG. 22 in another embodiment, the payload device 1400 includes a back-section 1410, a sling 1420, and mounting-components 1440. Sling 1420 replaces the function of the base and the payload-securing-components of the embodiment of FIG. 2. Sling 1420 is both inexpensive to manufacture and also can carry payloads that are made of smaller items or loose items and payloads that benefit from additional support. The back-section 1410 is made of flexible material or a rigid material, or a hybrid of the two. With a flexible material back-section, the material can be reinforced with a rigid member along key parts. For example the top edge may have a rigid member running its length. In another example, there could be a rigid member that runs diagonally across the back of the back-section, from the top forward corner to the bottom rear corner of the device. Such member might be matched with a similarly configured securing-strap, such as the brace 143 shown in FIG. 32 or with the securing-strap 1002 shown in FIG. 42. In some embodiments, sling 1410 has a slot-shaped opening 1412 at the bottom to help a bicycle wheel seat in the sling, as shown in FIG. 23. In other embodiments, sling 1410 has two swooped bottom bars 1414 that help catch and support a bicycle wheel, as shown in FIG. 24. In yet other embodiments, sling 1410 has a metal or plastic frame piece 1416 with a slot receptacle that helps catch and support a bicycle wheel, as shown in FIG. 25.

In the embodiment of FIG. 26, sling 1410 is a fabric sling without a frame around the perimeter of the device. Sling 1410 has reinforced ribs 1418 that are rigid in one dimension, yet flexible in the other. It also has a slot 1412 to accommodate the wheel of a payload-bicycle. This device can be rolled up for storage or for transport (when not mounted to a host-bicycle). It is made of a variety of materials including nylon fabric with plastic, metal bars, wood, or wire to create the rigidity for the ribs. Alternatively, sling 1410 is made with a stiff fabric or foam that has a natural rigidity to it potentially adding pressed creases to bias the material to fold or roll. For certain applications sling 1410 is made with a fabric (or other material) without ribbing or creased material or other reinforcements that create rigidity in one axis and permit bending in along another axis. Since those versions of the device are flexible in all orientations, those versions of the device are used on a host-bicycle that has a bicycle rack or bicycle frame that provides support behind the device, such that the device is not liable to flex into the rear wheel of the host-bicycle during use.

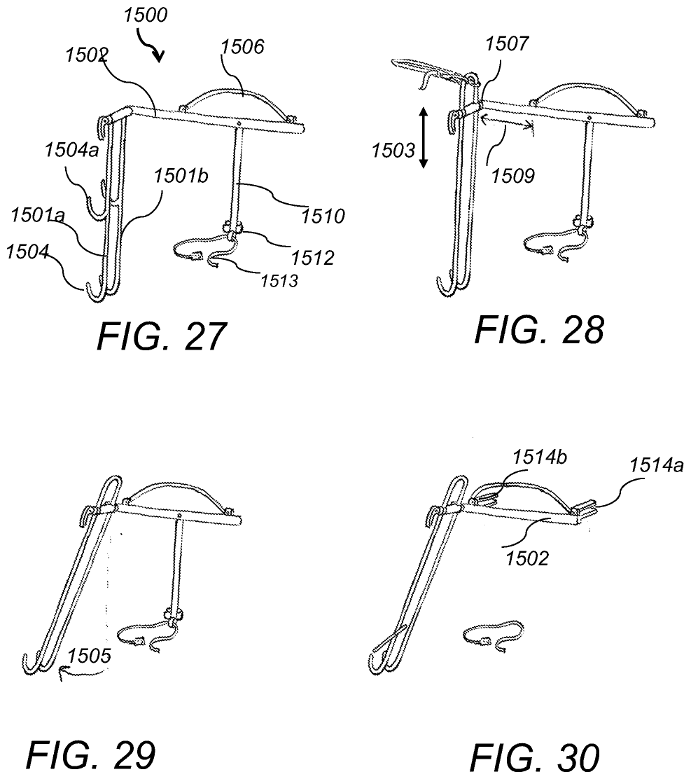

Referring to FIG. 27-FIG. 30, in another embodiment, the payload device 1500 is designed to tow payload-bicycles or wheels and includes a tubular frame having a horizontal tubular component 1502, and vertical components 1501a, 1501b, 1510, extending from the horizontal component 1502. Vertical components 1501a, 1501b are foldable and include hooks 1504 that are used for hanging the axle of a wheel of a payload bicycle. They quickly connect and disconnect to and from the rack of a host-bicycle via the mounting loop component 1506. Vertical components 1501a, 1501b are folded toward the horizontal component 1502 into a stowed position when not actively carrying a payload-bicycle or wheel. Vertical component 1510 is hooked to a lower portion of the host-bicycle's rack with a catch 1512 to secure the device 1500 against rotation. This component 1510 is also foldable toward the horizontal component 1502 into a stowed position when the device is not in use. Vertical component 1510 also serves as an anchor point to fasten the payload-bicycle's secured wheel to the device with strap 1513 for stabilization of the payload-bicycle. In some embodiments, the hanging length of hooks 1504 is adjustable by sliding the vertical components 1501a, 1501b up and down along direction 1503 at the pivot point 1507, as shown in FIG. 28, FIG. 29 and FIG. 30. Alternatively, additional hooks 1504a are incorporated along the length of the vertical components 1501a, 1501b at different heights in order to accommodate different sized bicycles, as shown in FIG. 27. Vertical components 1501a, 1501b cantilever out from the host-bicycle's rack by a distance 1509 to provide a setback position for the payload-bicycle's mounted wheel, as shown in FIG. 27 and FIG. 28. Alternatively, vertical components 1501a, 1501b are designed to hang at an angle 1505 to achieve the same setback position for the payload-bicycle's mounted wheel, as shown in FIG. 29. In some embodiments, horizontal component 1502 wraps around the top platform on the host-bicycle's rack and attaches to it via clamps 1514a, 1514b, as shown in FIG. 30. In this case, vertical component 1510 is omitted.

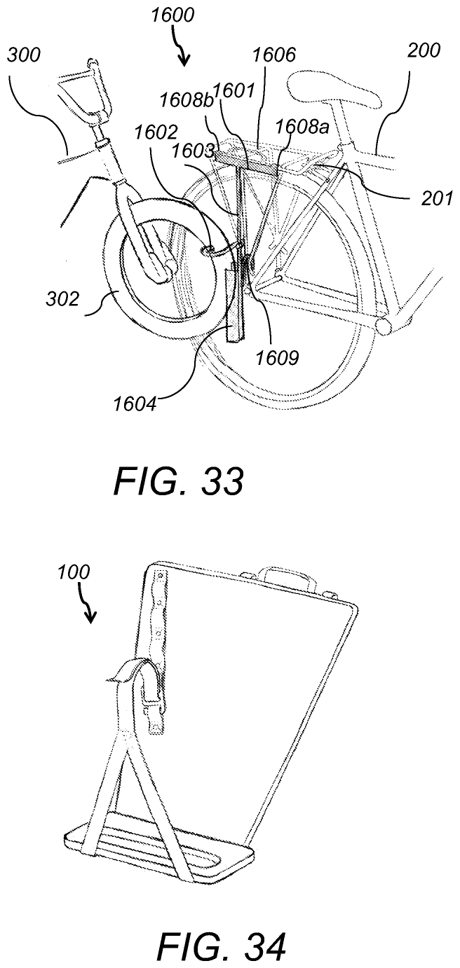

Referring to FIG. 33, in another embodiment, payload device 1600 includes a horizontal component 1601 and a vertical component 1603 that extends downward from 1601. Vertical component 1603 has a horizontally extending hook 1602 and a vertical channel 1604 for securing the payload-bicycle's wheel 302. The wheel 302 is constrained laterally in the channel 1604 and the hook 1602 in conjunction with gravity secures the wheel vertically. Because of the different geometry of the securing components, this embodiment does not need to cantilever off the back of the rear rack on the host bicycle in order to provide clearance for the host-bicycle's heel while pedaling. Device 1600 mounts to the host-bicycle's rack with a handle 1606 and quick release latches 1608a, 1608b at the top that latch onto a rail of the rear bicycle rack 201 and also with a catch hook 1609 at the bottom of the bicycle rack's supports. Device 1600 is constructed with steel tubing, steel bar, and steel channel, that are welded, riveted, brazed, or screwed together. Device 1600 can also be made with other materials, such other metals, alloys, or composites.

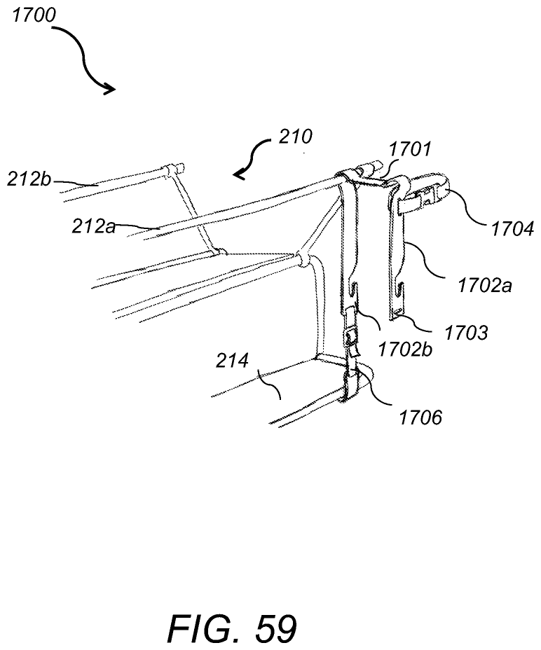

Referring to FIG. 59, payload device 1700 is designed to be used with a rear deck or top rack 210 that is typically on the rear of longtail bicycles. A rear deck is used for passengers to sit on or for mounting and carrying cargo on the bike. Around the passenger area is typically a “cage” or “monkey bars” which includes hand rails 212a, 212b. At the base of the frame in the rear area is what is often referred to as the running boards or side boards 214, which are platforms for passengers to rest their feet, as well as a base for securing cargo to the bicycle. Payload device 1700 includes two vertically extending slotted hooks 1702a, 1702b that extend from a horizontal bar 1701. Horizontal bar 1701 is mounted on the hand rail 212a and hook 1702b is secured at the bottom to the running board 214 by a hook at the end of strap 1706. Hooks 1702a, 1702b are used for hanging the axle of a wheel (usually the front wheel) of a payload bicycle.

FIG. 34 depicts an embodiment of the device 100, that is designed to carry primarily a payload bicycle. In this case, the tie down anchors 107 of FIG. 2 are not included.

In addition to embodiments of the invention that only carry bicycles there are also embodiments of the invention that only carry non-bicycle payloads. These versions include components for securing payloads, but omit the components dedicated to securing payload-bicycles.

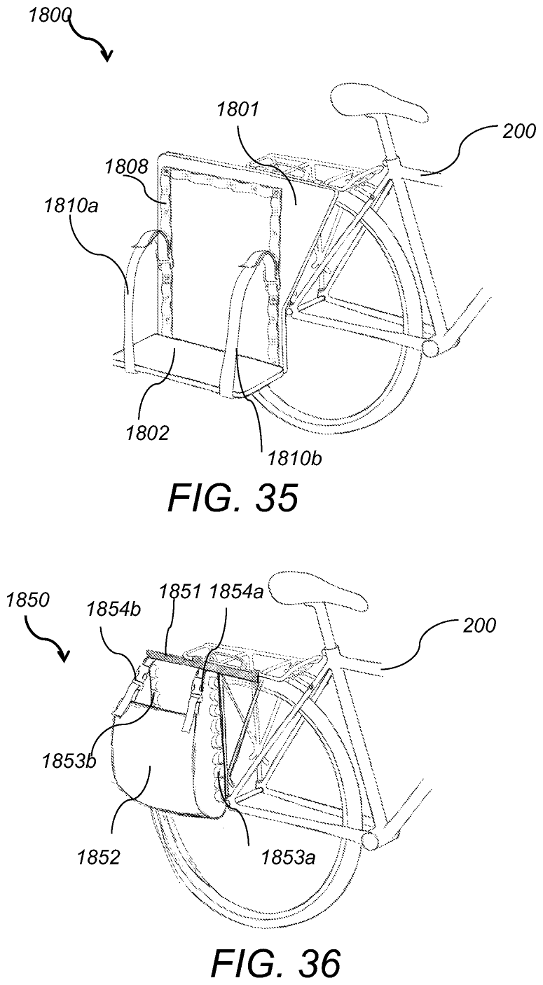

Referring to FIG. 35, a payload device 1800 that is designed to carry non-bicycle payloads includes a back-section 1801, a base 1802, two separated securing straps 1810a, 1810b and additional securing strap anchors 1808. Base 1802 is a rectangular board and back-section 1801 is a trapezoid-shaped board with an extended rectangular bottom portion. In one example, the back-section 1801 measures 12″ to 16″ inches long along the long edge of the base, 19″ to 23″ inches long along the top edge, and is 14″ to 20″ tall. The top edge of the back-section 1801 is cantilevered by 6″ to 10″ off the back of the rack. In one example, the base has a length of 12″ to 16″ inches and is 6″ to 11″ deep.

FIG. 36 depicts another payload device 1850 that is designed to carry non-bicycle payloads. Payload device 1850 includes a sling 1852 that can accommodate a variety of irregular payload forms and is adjustable to conform to differently sized objects with ease. Sling 1852 does not have a frame, and it is made primarily of fabric. The height of sling 1852 is adjusted by straps 1854a, 1854b in order to secure the cargo contents. Sling 1852 has two vertical strips of securing strap anchors 1853a, 1853b, on the leading and trailing edges, respectively, that enable the connection of additional straps in the fore/aft direction in order to further secure the cargo contents. The top edge of the sling is attached to a structural bar 8151 that allows it to cantilever and hang off of the rear of a conventionally sized rear bicycle rack. The setback from the cantilever provides enough clearance for the heel of the rider of the host-bicycle 200 to allow them to pedal while the device carries a low riding payload.

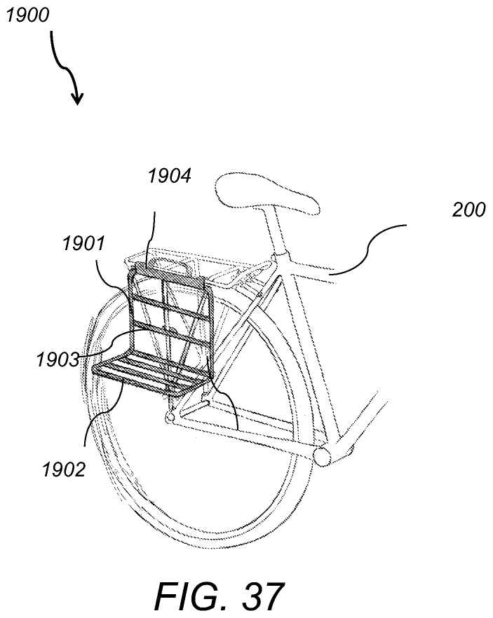

Referring to FIG. 37, an open frame payload device 1900 includes a tubular based back-section 1901 and a tubular based base 1902. Both the back-section 1901 and the base 1902 include cross bars 1903 extending from the leading edge to the trailing edge. A mounting bar 1904 is used to attach the device 1900 to the host-bicycle's rack. Mounting bar 1904 is bent on the top to form a hook and the hook is used to attach the device to the rack of the host-bicycle. The back-section 1901 is not as tall as in other embodiments and as such it does not need to cantilever off of the back of the rear bicycle rack to provide heel clearance for the rider of the host-bicycle 200. Device 1900 can also be mounted to a front rack on a host-bicycle. A payload is seated on the base and strapped in by a strap or bungee cord that runs around the payload and terminates on the two vertical pieces of tubing of the back-section 1901. In one example, a supermarket shopping bag is secured in this way. In another example, a moderate sized box rests on the base, overhanging the edges of the base, and also is secured in the same way. In a third example, a sleeping bag or a tent is laid down on the base, with the long side of the tent or sleeping bag running along the long side of the device's base, and with the payload overhanging the leading and trailing edges. The sleeping bag or tent are secured by a strap or straps terminating on the long edge of the base and on a cross tubing on the back-section. The open nature of this device allows for many alternative mounting points and many other configurations that can suit each particular payload. In one example, back-section 1901 and the base 1902 are made of steel or aluminum tubing, welded at the joints. The mounting plate 1904 is made of the same metal and is bent at the top to form a hook. There is also a catch on a cross tube that secures the device to a vertical support of the bicycle rack. In one example, base 1902 typically measures 8″ to 13″ inches long by 3″ to 9″ inches deep and the height typically measures 6″ to 12″ inches tall. Taller versions of this embodiment need to be cantilevered off the back of the rear rack when mounted on conventional sized racks.

FIG. 38 and FIG. 39 depict the device 150 of FIG. 13 mounted to the front rack of a host-bicycle 200. The back-section 151 is cantilevered distal to the rack along the top rail of the rack. Additionally, the base 152 is further cantilevered distal to the rack. There is a lot of space to mount large items as a payload without interference with the rider of the host-bicycle. However, the distal position of the payload will have a large impact on the responsiveness of the steering, since the distal loading position adds to the payload's moment of inertia. FIG. 39 depicts the device 150 mounted to the front rack of a host-bicycle 200 in the opposite orientation from FIG. 38. The device 150 is cantilevered distal to the rack along the top rail of the rack. However, the base is cantilevered proximally on the rack, ultimately locating the base in a relatively central location on the front wheel. While there is a lot of space to mount large items without interference with the rider of the host-bicycle 200, there is less space than in FIG. 38. However, the central positioning of the payload will have an improved responsiveness of the steering compared with the mounting orientation in FIG. 38, since the relatively central loading position minimizes the payload's moment of inertia.

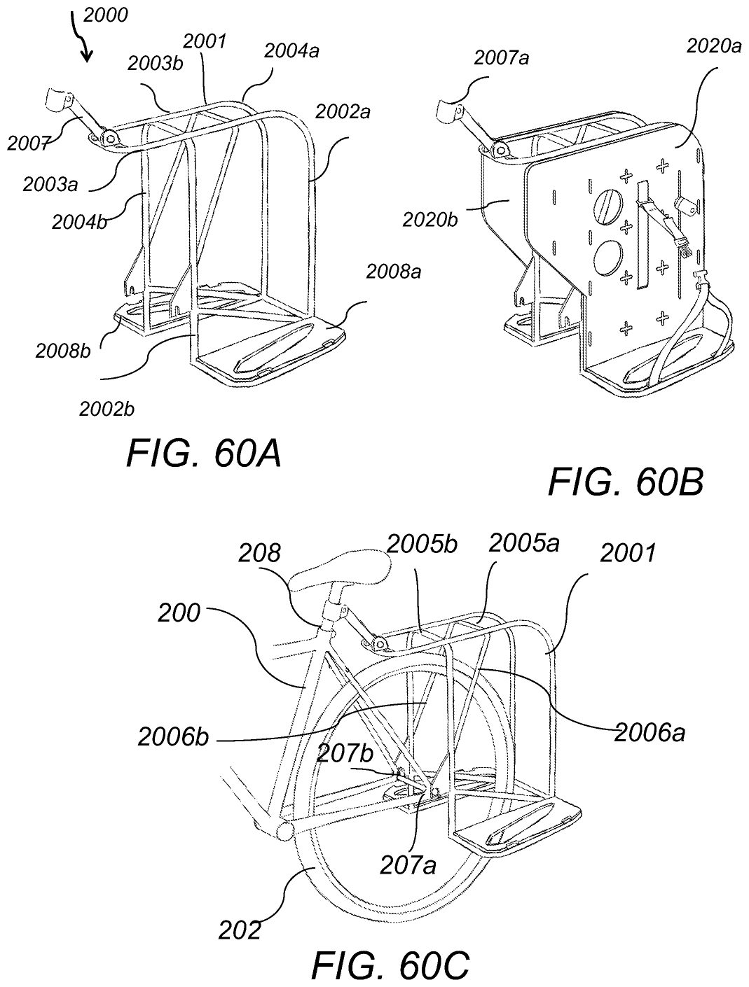

Referring to FIG. 60A-FIG. 60C, in yet another embodiment, payload device 2000 includes first and second back-sections 2020a, 2020b, first and second bases 2008a, 2008b, and a frame 2001. Frame 2001 functions as an over the wheel 202 mountable rack and includes tubular vertical components 2002a, 2002b, 2004a, 2004b extending downward from horizontal components 2003a, 2003b, cross components 2005a, 2005b, diagonally extending components 2006a, 2006b, and a bicycle connecting component 2007. Vertical components 2002a, 2002b, 2004a, 2004b and horizontal components 2003a, 2003b support the first and second back-sections 2020a, 2020b, respectively, as shown in FIG. 60B. Cross components 2005a, 2005b connect the horizontal components 2003a, 2003b and form the top of the bicycle rack. Payload assembly 2000 is mounted over the rear wheel 202 of the host-bicycle 200 and the diagonal components 2006a, 2006b are secured to the rear wheel axle 207 by the axle nuts 207a, 207b, respectively. Payload assembly 2000 is also secured to the seat tube 208 via a clamp 2007a. The structures of the back-sections 2020a, 2020b, and the bases 2008a, 2008b and the payload-securing components are similar to the ones in the embodiment of FIG. 44A. In one example, the frame components are made of steel or aluminum tubing, and are welded at the joints or bent. In other embodiments, the back-sections 2020a, 2020b are made of tubular components that are part of the frame 2001 and the payload securing components connect directly to the frame 2001.

Several embodiments of the present invention have been described. Nevertheless, it will be understood that various modifications may be made without departing from the spirit and scope of the invention. Accordingly, other embodiments are within the scope of the following claims.

What is claimed is:

1. A payload device capable of attaching to a host-bicycle and carrying a payload-bicycle or other cargo objects comprising:
a back-section, a base, and payload-securing components;
wherein the back-section comprises a vertically extending structure and the base comprises a horizontally extending structure and wherein a bottom edge of the back-section is adjacent to a back edge of the base;
wherein the base comprises an elongated opening shaped and dimensioned to accommodate a wheel of the payload bicycle; and
wherein the payload-securing components are capable of removably attaching the wheel of the payload bicycle or other cargo objects to the back-section.

2. The device of claim 1, wherein the back-section comprises a vertically-extending flat board and the base comprises a horizontally-extending flat board.

3. The device of claim 1, wherein the back-section comprises a vertically-extending tubular frame and the base comprises a horizontally-extending tubular frame.

4. The device of claim 3, wherein the back-section further comprises a sheet connected to the tubular frame.

5. The device of claim 1, wherein the base comprises angled support brackets or U-shaped support brackets.

6. The device of claim 1, wherein the elongated opening of the base extends diagonally at an angle relative to the back edge of the base.

7. The device of claim 1, wherein the base is hingeably connected to the back-section and foldable toward the back-section.

8. The device of claim 1, wherein the base further comprises an integrated stabilizer support.

9. The device of claim 1, wherein the back-section is foldable along one or more locations.

10. The device of claim 1, wherein a leading edge of the base is set back relative to the host-bicycle's rear wheel axle.

11. The device of claim 1, wherein the payload-securing components comprise one or more straps and one or more strap anchors.

12. The device of claim 1, wherein the payload-securing components comprise a fork catcher, or a trip-prevention nub.

13. The device of claim 1, further comprising mounting components capable of removably attaching the payload device to the host bicycle.

14. The device of claim 13, wherein the mounting components comprise a mounting bar and wherein the mounting bar is capable of attaching to a location of the host-bicycle and wherein said location comprises one of a seat post, seat tube, seat stay, chainstay, seat stay eyelets, or bicycle rack.

15. The device of claim 13, wherein the mounting components are capable of attaching the back-section to a location of the host-bicycle and wherein said location comprises one of a seat post, seat tube, seat stay, chainstay, seat stay eyelets, dropout eyelets, wheel axle, or bicycle rack.

16. The device of claim 13, wherein the mounting components comprise a mounting U-bar and wherein the mounting U-bar is capable of attaching to a location of the host-bicycle and wherein said location comprises one of a rear dropout eyelets, seat stay, chainstay, or wheel axle.

17. The device of claim 13, wherein the mounting components comprise one or more latches, a catch, a latch-rail and a catch-rail and wherein the latch-rail and catch-rail are mounted on a back surface of the back-section and the one or more latches and the catch are slidably mounted to the latch-rail and catch-rail, respectively.

18. The device of claim 13, wherein the mounting components comprise one or more of J-hooks, a handle, a tension hook, a tension hook guide, or a bungee cord.

19. The device of claim 1, wherein the back-section comprises components integrated on a back-section surface and wherein said integrated components comprise at least one of tracks, slots and wherein said tracks extend horizontally, vertically, or arcwise and wherein said slots comprise one of linear shapes, arc shapes, U-shapes, circular shapes, oval shapes, cross-shapes, or H-shapes.

20. The device of claim 1 further comprising a bicycle rack mountable over a wheel of the host-bicycle and wherein the back-section is mounted to the bicycle rack.

21. The device of claim 1 further comprising a trip-prevention strap having a first end connectable to the payload-bicycle and a second end connectable to the host-bicycle.
